(19) United States
(12) Patent Application Publication
(10) Pub. No.: US 2024/0168053 A1
(43) Pub. Date: May 23, 2024

(54) Nano-Mechanical Infrared Spectroscopy System and Method Using Gated Peak Force IR

(71) Applicants: Bruker Nano, Inc., Santa Barbara, CA (US); Lehigh University, Bethlehem, PA (US)

(72) Inventors: Martin Wagner, Goleta, CA (US); Shuiqing Hu, Santa Barbara, CA (US); Henry Mittel, Santa Barbara, CA (US); Weijie Wang, Thousand Oaks, CA (US); Chanmin Su, Ventura, CA (US); Xiaoji Xu, Bethlehem, PA (US)

(21) Appl. No.: 18/514,613

(22) Filed: Nov. 20, 2023

Related U.S. Application Data
(60) Provisional application No. 63/426,946, filed on Nov. 21, 2022.

(51) Int. Cl. G01Q 60/34; G01Q 20/04; G01Q 30/02

(52) U.S. Cl. CPC G01Q 60/34; G01Q 20/04; G01Q 30/02

(57) ABSTRACT

An apparatus and method of performing sample characterization with an AFM and a pulsed IR laser directed at the tip of a probe of the AFM. Gated laser pulsing and gated detection based on a lock-in amplifier, boxcar integrator or FFT may be employed in Peak force tapping operation. Nano-spectroscopic measurements with sub-20 nm, and even sub-10 nm resolution can be executed together with nano-mechanical and other property measurements.

### BACKGROUND OF THE INVENTION

### Field of the Invention

The preferred embodiments are directed to making nano-mechanical and spectroscopy measurements, and more particularly, using peak force tapping (PFT) as the oscillating mode of AFM operation and gated multi-pulse excitation and detection to obtain nanoscale localized spectroscopy and/or imaging of a sample together with its nano-mechanical and other properties.

### Description of Related Art

Infrared spectroscopy and scanning probe microscopy (SPM) have been combined to perform a method of spectroscopy that integrates an infrared light source, e.g., a tunable free electron laser, an optical parametric oscillator or a quantum cascade laser with an atomic force microscope (AFM) having a sharp probe that measures the local absorption of infrared light by a sample. Conventional techniques in this regard are based on contact-mode AFM and extract the absorption signal from contact resonance oscillations that occur when the sample expands (or contracts) during light absorption. Recently, a tapping mode based AFM technique using IR illumination has been shown to yield a spatial resolution down to 10 nm. Even more recently, PeakForce IR, an IR spectroscopy and imaging mode based on Peak Force tapping AFM operational mode has been developed with 10 nm resolution.

In general the interaction between a sample under test and electromagnetic energy can be monitored to yield information concerning the sample. In spectroscopy, transmission of light through a sample or its reflection off a sample results in a sample-characteristic plot of transmitted or reflected intensity as a function of wavelength. This spectroscopic information allows users to determine the physical properties of the sample, such as chemical composition or temperature.

Notably, making spectroscopic measurements with a spatial resolution on the nanoscale is continuing to improve. However, despite ongoing progress in the development of imaging techniques with spatial resolution beyond the diffraction limit, simultaneous spectroscopic implementations delivering chemical specificity and sensitivity on the molecular level have remained challenging.

SPMs are facilitating improvements in this area. AFMs are devices which typically employ a probe having a tip and causing the tip to interact with the surface of a sample with appropriate forces to characterize the surface down to atomic dimensions. Generally, the probe is introduced to a surface of a sample to detect changes in the characteristics of a sample. By providing relative scanning movement between the tip and the sample, surface characteristic data can be acquired over a particular region of the sample and a corresponding map of the sample can be generated.

A typical AFM system is shown schematically in FIG. 1. An AFM 10 employing a probe device 12 including a probe 14 having a cantilever 15. Scanner 24 generates relative motion between the probe 14 and sample 22 while the probe-sample interaction is measured. In this way images or other measurements of the sample can be obtained. Scanner 24 is typically comprised of one or more actuators that usually generate motion in three orthogonal directions (XYZ). Often, scanner 24 is a single integrated unit that includes one or more actuators to move either the sample or the probe in all three axes, for example, a piezoelectric tube actuator. Alternatively, the scanner may be an assembly of multiple separate actuators. Some AFMs separate the scanner into multiple components, for example an XY scanner that moves the sample and a separate Z-actuator that moves the probe. The instrument is thus capable of creating relative motion between the probe and the sample while measuring the topography or some other surface property of the sample as described, e.g., in Hansma et al. U.S. Pat. No. RE 34,489; Elings et al. U.S. Pat. No. 5,266,801; and Elings et al. U.S. Pat. No. 5,412,980.

In a common configuration, probe 14 is often coupled to an oscillating actuator or drive 16 that is used to drive probe 14 at or near a resonant frequency of cantilever 15. Alternative arrangements measure the deflection, torsion, or other motion of cantilever 15. Probe 14 is often a microfabricated cantilever with an integrated tip 17.

Commonly, an electronic signal is applied from an AC signal source or drive 18 under control of an SPM controller 20 to cause actuator 16 to drive the probe 14 to oscillate (and/or a scanner 24 to oscillate the sample, for example). The probe-sample interaction is typically controlled via feedback by controller 20. Notably, the actuator 16 may be coupled to scanner 24 and probe 14 but may be formed integrally with the cantilever 15 of probe 14 as part of a self-actuated cantilever/probe.

Often a selected probe 14 is oscillated and brought into contact with sample 22 as sample characteristics are monitored by detecting changes in one or more characteristics of the oscillation of probe 14, as described above. In this regard, a deflection detection apparatus 25 is typically employed to direct a beam towards the backside of probe 14, the beam then being reflected towards a detector 26. As the beam translates across detector 26, appropriate signals are processed at block 28 to, for example, determine RMS deflection and transmit the same to controller 20, which processes the signals to determine changes in the oscillation of probe 14. In general, controller 20 generates control signals to maintain a relative constant interaction between the tip and sample (or deflection of the lever 15), typically to maintain a setpoint characteristic of the oscillation of probe 14. More particularly, controller 20 may include a PI Gain Control block 32 and a High Voltage Amplifier 34 that condition an error signal obtained by comparing, with circuit 30, a signal corresponding to probe deflection caused by tip-sample interaction with a setpoint. For example, controller 20 is often used to maintain the oscillation amplitude at a setpoint value, A_{S}, to insure a generally constant force between the tip and sample. Alternatively, a setpoint phase or frequency may be used.

A workstation 40 is also provided, in the controller 20 and/or in a separate controller or system of connected or stand-alone controllers, that receives the collected data from the controller and manipulates the data obtained during scanning to perform point selection, curve fitting, and distance determining operations.

AFMs may be designed to operate in a variety of modes, including contact mode and oscillating mode. Operation is accomplished by moving either the sample or the probe assembly up and down relatively perpendicular to the surface of the sample in response to a deflection of the cantilever of the probe assembly as it is scanned across the surface. Scanning typically occurs in an “x-y” plane that is at least generally parallel to the surface of the sample, and the vertical movement occurs in the “z” direction that is perpendicular to the x-y plane. Note that many samples have roughness, curvature and tilt that deviate from a flat plane, hence the use of the term “generally parallel.” In this way, the data associated with this vertical motion can be stored and then used to construct an image of the sample surface corresponding to the sample characteristic being measured, e.g., surface topography. In one mode of AFM operation, known as TappingMode™ AFM (TappingMode™ is a trademark of the present assignee), the tip is oscillated at or near a resonant frequency of the associated cantilever of the probe. A feedback loop attempts to keep the amplitude of this oscillation constant to minimize the “tracking force.” i.e. the force resulting from tip/sample interaction. Alternative feedback arrangements keep the phase or oscillation frequency constant. As in contact mode, these feedback signals are then collected, stored, and used as data to characterize the sample. Note that “SPM” and the acronyms for the specific types of SPMs, may be used herein to refer to either the microscope apparatus or the associated technique, e.g., “atomic force microscopy.” In a recent improvement on the ubiquitous TappingMode™, called Peak Force Tapping® (PFT) Mode, discussed in U.S. Pat. Nos. 8,739,309, 9,322,842 and 9,588,136, which are expressly incorporated by reference herein, feedback is based on force (also known as a transient probe-sample interaction force) as measured in each oscillation cycle.

Regardless of their mode of operation, AFMs can obtain resolution down to the atomic level on a wide variety of insulating or conductive surfaces in air, liquid, or vacuum by using piezoelectric scanners, optical lever deflection detectors, and very small cantilevers fabricated using photolithographic techniques. Because of their resolution and versatility, AFMs are important measurement devices in many diverse fields ranging from semiconductor manufacturing to biological research.

Infrared (IR) spectroscopy is a useful tool in many analytical fields such as polymer science and biology. Conventional IR spectroscopy and microscopy, however, have resolution on the scale of many microns, limited by optical diffraction. It has become apparent that it would be particularly useful to perform IR spectroscopy on a highly localized scale, on the order of biological organelles or smaller, at various points on a sample surface. That way, information about the composition of the sample, such as location of different materials or molecular structures, could be obtained.

Conventional far field infrared (IR) spectroscopy is a widely used technique to measure the characteristics of material. In many cases, the unique signatures of IR spectra can be used to identify unknown material. IR spectroscopy is performed on bulk samples which gives compositional information but not nanoscale structural information since, as just noted. IR spectroscopy allows collection of IR spectra with a limited resolution on the scale of many microns. Far-field localization techniques can achieve spatial resolution down to about 20 nm by point-spread function reconstruction but typically rely on fluorescence from discrete molecular or quantum dot emitters, with limited chemically specific information.

Scattering scanning near-field optical microscopy (s-SNOM) has been applied to some degree in infrared spectroscopy and imaging. In scattering-type SNOM (s-SNOM) external illumination of the sharp (metallic or semi-conducting) AFM probe tip leads to detectable light scattering from the near-field probe-sample interaction region—light scattering that is specific to the material under the tip. Alternative approaches such as coherent anti-Stokes Raman spectroscopy (CARS), or tip-enhanced Raman scattering (TERS) are also chemically sensitive but are also based on detection of scattered light from the sample.

Despite ongoing progress in the development of imaging techniques with spatial resolution beyond the diffraction limit, spectroscopic implementations delivering chemical specificity and sensitivity on the molecular level have remained challenging. What follows is a discussion of techniques that rely on mechanical detection of IR absorption in contrast to optical detection implemented, for example, in s-SNOM, CARS or TERS.

One technique based on use of an AFM to produce such localized spectra is described in a publication entitled “Local Infrared Microspectroscopy with Sub-wavelength Spatial Resolution with an Atomic Force Microscope Tip Used as a Photo-thermal Sensor” (PTIR) Optics Letters, Vo. 30, No. 18. Sep. 5, 2005. The technique is also discussed in U.S. Pat. No. 8,402,819 (The '819 patent). Those skilled in the art will comprehend the details of the technique in the publication but the technique will be described briefly here for clarity. A more recent review of the AFM-IR techniques based on photothermal detection is given in Mathurin et al., Journal of Applied Physics, 2022, 131, 010901.

Referring to the '819 patent, in PTIR, infrared radiation is incident on a region of a sample. At a wavelength absorbed by the sample, the absorption will typically cause a local increase in temperature and a rapid thermal expansion of the sample. A probe is arranged to interact with the sample and transducer to generate a signal related to the absorbed IR energy in the region under the probe tip. “Interact” means positioning the probe tip close enough to the sample such that a probe response can be detected in response to absorption of IR radiation. For example, the interaction can be contact mode, tapping mode or non-contact mode. An associated detector can be used to read one or more probe responses to the absorbed radiation. The induced probe response may be a probe deflection, a resonant oscillation of the probe (flexural, torsional, lateral, etc.), and/or a thermal response of the probe (e.g., temperature change). For probe deflection and/or resonant oscillation of the probe, appropriate detectors can include an optical beam-bounce arrangement with split segment photodiodes along with any associated amplification and signal conditioning electronics. In the case of a thermal response, the appropriate detector may comprise, for example, a Wheatstone bridge, a current and/or voltage amplifier and/or other associated electronics to sense, amplify, and condition the thermal signal from the probe. The probe response is then measured as a function of the wavelength of incident radiation to create an absorption spectrum. From the spectra, material in the sample can be characterized and/or identified.

As noted in the '819 patent, an AFM set-up was used with a bottom-up illumination scheme where the sample is mounted on a ZnSe prism and the light is transmitted from below. A pulsed IR source, in this case a Free Electron Laser (FEL) beam, is directed into the prism and hits the sample at an angle where Total Internal Reflection occurs in order for the beam to be propagative in the sample and evanescent in the air. Thus, only the sample is significantly exposed to the laser radiation, and the AFM probe is minimally exposed to the beam. The probe is placed at a point on the sample by the scanner and is held at an average height by feedback electronics. Both the vertical and lateral deflection signal, as well as the feedback signal, may be monitored.

When the FEL is pulsed, the sample may absorb some of the energy, resulting in a fast thermal expansion of the sample as shown in FIG. 3 of the '819 patent. This has the effect of a quick shock to the cantilever arm, which, if the ability of the cantilever to respond to this shock is slower than the shock, will result in exciting a resonant oscillation in the cantilever. Because the absorbed energy is ideally contained within the sample, this shock is due primarily to rapid sample expansion, as minimal IR energy is absorbed by the cantilever itself. Although the probe is kept in contact with the surface by the feedback electronics, the resonant signal is too fast for the feedback electronics, but can be observed directly from the photodetector. Thus the cantilever rings down while still in contact with the surface, an effect called “contact resonance.” The absolute deflection, amplitude, and frequency characteristics of the contact resonance vary with the amount of absorption, as well as other properties, such as the local hardness, of the localized area around the probe tip, for example, by analyzing the ringdown and/or the Fourier transform (FFT) of the ringdown events. Also, depending on the direction of the expansion, vertical resonances, lateral or torsional resonances, or all can be excited.

Resonance enhanced PTIR is a recent method that provides improved signal levels and spatial resolution, as described in U.S. Pat. No. 8,869,602 and in publication Lu et al. “Tip-enhanced infrared nanospectroscopy via molecular expansion force detection”, Nature Photonics 8, 307 (2014). Improved sensitivity and spatial resolution are arguably achieved using field-enhancement at the AFM tip (as also present in s-SNOM or TERS) together with resonant excitation of a cantilever mode, e.g., a bending mode or a contact resonance mode. The latter may be achieved with an IR laser pulsing at the same frequency as the 2^{nd} cantilever bending mode while the AFM is operated in contact mode and photoexpansion is detected. A spatial resolution of 25 nm was observed, although only on ˜2 nm thin films. In addition, the films were deposited on an Au substrate, resulting in significant field enhancement in the substrate-tip cavity that is occupied by the sample. This scheme apparently requires substrate enhancement and hence limits its applicability to thin films that can be deposited on those substrates. Furthermore, AFM contact mode has severe drawbacks compared to intermittent contact (e.g., tapping) mode or peak force tapping mode in the form of tip/sample contamination, tip or sample wear and poor performance on soft, sticky or loose samples. Especially tip contamination or tip wear may present a severe drawback here since any change in the tip geometry or surface influences the field distribution and field-enhancement at the apex. Another improvement came with the use of a bench-top QCL instead of an FEL which is a large user-facility laser. Other lasers such as optical parametric oscillators operating in the 2-10 micron wavelength range also became available to complement the 5-12 micron range of a typical QCL.

Another recently developed technique is photo-induced force microscopy (PiFM), described in patent U.S. Pat. No. 8,739,311 which is essentially identical to tapping mode IR. Here, AFM is operated in tapping mode on one mechanical resonance of the cantilever (typically in the 500-1500 kHz range) while PiFM detection is performed at a different cantilever mode with the IR laser tuned to the difference-frequency. Like PTIR, PiFM detects a mechanical motion, but instead of photoexpansion as in PTIR, PiFM claims to be driven by the photo-induced dipole-dipole force between tip and sample. High sensitivity and spatial resolution down to 10 nm is claimed to have been observed. Currently, the requirement to match the laser frequency to the difference frequency of certain cantilever modes limits the IR source to QCL lasers as in the case of resonance enhanced PTIR. Also, the cantilever modes may shift in frequency depending on the material under the tip, thus requiring a tracking mechanism for the frequency shift that adjusts the laser frequency accordingly. Importantly, PiFM relies on resonant tapping, which as described below is in contrast to the Peak Force Tapping® mode based method of the present preferred embodiments where the probe oscillation occurs far below (at least 5×) the cantilever resonance.

In another technique, known as Peak Force IR and described in U.S. Pat. Nos. 8,955,161, 9,207,167, 9,719,916 and 10,520,426 which are expressly incorporated by reference herein, Peak Force Tapping® mode AFM is combined with directing light overhead of the sample and locally exciting the photothermal response at the tip-sample interface. Resolution is improved and sample preparation is minimized. The method identifies a change in modulus based on the directing step to provide an indicator of IR absorption by the sample. Measuring techniques sensitive to modulus change, such as peak force tapping (PFT) AFM mode, or contact resonance mode, may be employed.

The acronym Peak Force IR (PFIR) is more commonly referring to a more recent, related technique. PFIR is a peak force tapping-based method of AFM-IR where the IR laser induced sample response is detected during the PFT cycle so that chemical and nanomechanical information of the sample can be obtained. The principle of operation is described in U.S. Pat. No. 10,845,382 or more recently in Wang et al., Chem. Soc. Rev., 2022, 51, 5268-5286 or Mathurin et al., Journal of Applied Physics, 2022, 131, 010901. In short, when the laser pulse is absorbed by the sample during the tip-sample contact time within the PFT cycle, the cantilever deflection is modified and this change is detected. Usually this change is an oscillation or an offset in the deflection signal. Originally a single laser pulse in a first PFT cycle had been employed with no IR laser illumination for the subsequent cycle in order to remove the slowly varying cantilever deflection background by subtracting cycle two from cycle one. Later implementations (Wang et al., Nano Lett. 20, 3986, (2020)) removed the slowly-varying background via a fitting procedure before an FFT for signal extraction. However, despite the successful demonstration of PFIR microscopy, its popularity is limited by the complexity of its customized signal generation and processing routine. A typical PFIR microscope requires hardware or software-level programming on signal acquisitions and processing for background fitting, background subtraction and FFT extraction, which often involves programming with LabVIEW or equivalent platforms.

Continued improvement is desired for broader adoption and better performance of this peak force tapping based IR technique that combines nanoscale chemical identification with nano-mechanical characterization.

### SUMMARY OF THE INVENTION

Using Peak Force Tapping® (PFT) mode AFM, the preferred embodiments overcome the drawbacks of the prior art. In the preferred embodiment gated pulsing during the contact time and gated detection using a lock-in amplifier without background subtraction reduces complexity.

In one preferred embodiment, an apparatus for performing spectroscopy of sub-micron regions of a sample with an atomic force microscope (AFM), includes a drive that generates an oscillating drive signal to cause a probe of the AFM to interact with the sample for multiple probe-sample interaction cycles, so as to produce a transient probe-sample interaction force, with the oscillating drive signal having a frequency below a resonance frequency of the probe. In addition, the AFM includes at least one controller to control the transient probe-sample interaction force, and a tunable light source to illuminate the tip-sample region with light pulses to induce a sample modification. A detector is provided to measure probe deflection due at least in part to the induced sample modification. And at least one of a lock-in amplifier and a signal integrator is provided to extract sample responses to the light pulses from the measured probe deflection.

According to another aspect of this embodiment, the at least one of a lock-in amplifier and a signal integrator is a lock-in amplifier, and the sample responses are phase sensitive, and wherein the phase sensitive sample responses are averaged.

According to another aspect of this embodiment, the at least one controller creates a spatially resolved map indicative of absorbed infrared radiation using the sample responses, wherein the map is created over a region of the sample with at least 100×100 pixels in less than 5 minutes.

In a further aspect of this embodiment, the oscillating drive signal frequency is at least 5× below the lowest resonance frequency of the probe.

According to yet another aspect of this embodiment, the controller times the pulses between probe-sample interaction cycles so as to cause a 180-degree phase change in the light induced probe deflection between at least two cycles, and subtracts the probe deflections corresponding to the at least two cycles. A sample response from the subtracted probe deflections is then extracted.

According to further aspects of this embodiment, at least one of the light pulses and extracted sample responses is gated during the probe-sample contact time. Moreover, the at least one of the light pulses and extracted sample responses may be gated in every cycle of probe-sample interaction. Also, the controller may extract at least one of a nano-mechanical property and a nano-electrical property from the sample responses.

In another aspect of this embodiment, the phase-sensitive lock-in amplifier output is averaged in contrast to averaging the amplitude, resulting in lower noise and hence an increased signal-to-noise ratio.

In particular, a method of performing spectroscopy of sub-micron regions of a sample with an atomic force microscope (AFM) is provided. In a first step, a probe of the AFM is caused to interact with the sample for multiple probe-sample interaction cycles, so as to produce a transient probe-sample interaction force. In this case, an oscillating drive signal has a frequency below the resonance frequency of the probe. Next, the method includes controlling the transient probe-sample interaction force, and then illuminating the tip-sample region with pulses of a tunable light source to induce a sample modification, preferably during the tip-sample contact time. Then, the method includes measuring probe deflection that is due at least in part to the induced sample modification. Finally, the method includes extracting a sample response, which may or may not be gaged to tip-sample contact time.

Additionally, the extracting step may include providing at least one of a lock-in amplifier and a signal integrator to extract the sample responses only during the tip-sample contact time. If, for example, the extracting step employs a lock-in amplifier, the sample responses are phase sensitive, and the method may further include averaging the phase sensitive sample responses.

According to another aspect of this embodiment, the method further includes creating a spatially resolved map indicative of absorbed infrared radiation using the sample responses, wherein the map is created over a region of the sample with at least 100×100 pixels in less than 5 minutes.

In an additional preferred embodiment, a method of performing spectroscopy of sub-micron regions of a sample with an AFM is again provided. The probe of the AFM is caused to interact with the sample for multiple probe-sample interaction cycles, so as to produce a transient probe-sample interaction force. In this case, an oscillating drive signal has a frequency below the resonance frequency of the probe. Next, the method includes controlling the transient probe-sample interaction force and illuminating the tip-sample region with pulses of a tunable light source to induce a sample modification during the tip-sample contact time. Then, probe deflection that is due at least in part to the induced sample modification is measured. Finally, sample responses to the light pulses from the measured probe deflection are extracted, wherein this extracting step may be gated.

The extracting step may also include providing at least one of a lock-in amplifier, an FFT block, and a signal integrator to extract the sample responses only during the tip-sample contact time. The sample responses may be phase sensitive such that the phase sensitive sample responses may be averaged.

The method in this additional preferred embodiment may further include (i) timing the pulses between probe-sample interaction cycles so as to cause a 180-degree phase change in the light induced probe deflection between at least two cycles, (ii) subtracting the probe deflections corresponding to the two cycles, and (iii) extracting a sample response from the subtracting step. Furthermore, a spatially resolved map indicative of absorbed infrared radiation using the sample responses may be created. The map may be created over a region of the sample with at least 100×100 pixels in less than 5 minutes, and the resolution of the sample response map may be sub-20 nm.

In yet another preferred embodiment, a method of performing spectroscopy using an AFM is provided. The method includes causing a probe of the AFM to interact with the sample for multiple cycles, so as to produce a probe-sample interaction force with an oscillating drive signal. The method further involves providing a pulsed light source to generate a plurality of pulses having a pulse width and directing the pulses at the sample where the probe is located causing an induced sample response. The pulses may substantially coincide with the probe-sample contact time. The probe deflection that is due at least in part to the induced sample response is measured. At least one characteristic of the sample response is derived. Additionally, the directing step of the method may be gated during probe-sample contact time and the measuring step may be gated during the probe-sample contact time in every cycle of the causing step.

This other preferred embodiment may further include creating a spatially resolved map indicative of absorbed infrared radiation using the sample responses. The map may be created over a region of the sample with at least 100×100 pixels in less than 5 minutes. The resolution of the sample responses may be sub-20 nm or even sub 10 nm. According to another feature, at least one of the illuminating step and the extracting step is gated during the probe-sample contact time. Additionally, the at least one of the illuminating step and the extracting step may be gated in every cycle of the causing step.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a schematic illustration of a Prior Art atomic force microscope AFM;

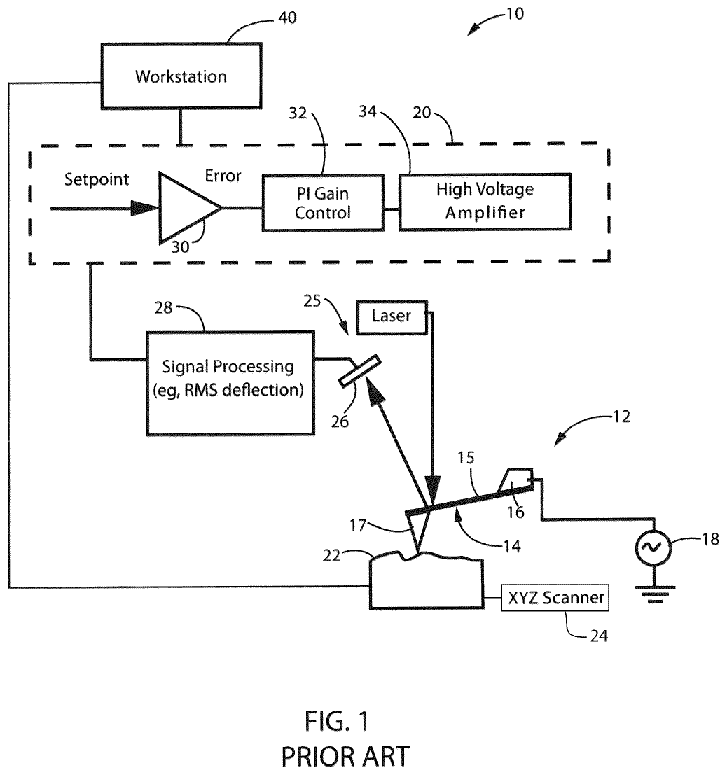

FIG. 2 is a schematic illustration of the gated peak force IR (PFIR) set-up of the preferred embodiments;

FIG. 3 is a plot of PFT deflection vs. time illustrating the laser-driven probe response during gated pulsing, according to a preferred embodiment;

FIGS. 4A-4D depicts the pulsing and read-out scheme based on the PFT deflection vs. time for laser pulsing that is synchronized with the PFT deflection cycle. According to a preferred embodiment, no phase change in the pulsing sequence occurs for consecutive PFT cycles;

FIGS. 5A-5D are plots of PFT deflection vs. time showing a 180-degree phase change between laser pulses in consecutive PFT cycles, according to a preferred embodiment, as well as a measurement showing in-contact oscillations that can be removed in the preferred embodiments;

FIGS. 6A-6C are plots illustrating an alternative gated detection scheme, according to a preferred embodiment;

FIGS. 7-10 shows the negative effects of continuous pulsing and continuous detection compared to the gated pulsing and detection of a preferred embodiment, FIG. 7 being a graph of laser repetition rate vs. IR signal, FIG. 8 being a schematic AFM block diagram of a set-up to acquire intensity maps during a typical alignment step in PFIR, FIG. 9 depicting images using the set-up of FIG. 8, and FIG. 10 being a graph of wave number vs. normalized Lock-in amplitude;

FIGS. 11A-11F present imaging, spectroscopy and correlated nano-mechanical measurements taken with an instrument according to a preferred embodiment;

FIGS. 12A-12C present high-resolution nano-IR absorption imaging data with sub-10 nm resolution obtained with an instrument according to a preferred embodiment; and

FIG. 13 is a flow diagram of a method according to the preferred embodiments.

### DETAILED DESCRIPTION OF THE PREFERRED EMBODIMENTS

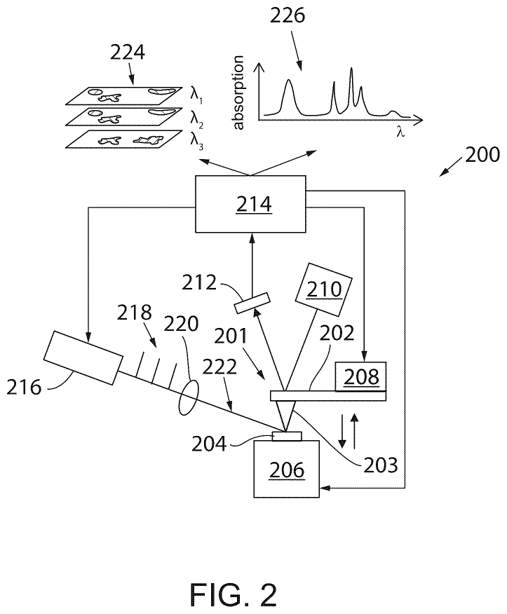

Turning to FIG. 2 the experimental setup 200 is described for an embodiment of the invention. A probe 201 with a cantilever 202 that is terminated into a sharp tip 203 is engaged on a sample of interest 204. The IR probes 201 are preferably coated with metal such as Au or PtIr in order to provide field enhancement from the lightning rod effect and light localization under the tip 203. Sample 204 is mounted on a stage 206 of the atomic force microscope that includes a three-dimensional piezo scanner. A piezo 208 may be attached to the cantilever 202. The AFM is capable of peak-force tapping operation (e.g., Bruker's Dimension Icon® or Multimode® AFM). The sample stage 206 and/or the piezo 208 provide a relative vertical motion between tip and sample while 206 can also deliver an in-plane XY motion for sample scanning. The vertical deflection of probe 201 is detected using conventional beam-bounce optical detection with a diode laser 210 and a position sensor 212 (e.g., 4-quadrant photodetector). The vertical deflection is measured and routed to the controller 214 for AFM feedback, e.g., controller 214 controls the z-position of sample 204 using stage/xyz scanner 206 or piezo 208. Notably, and importantly, the atomic force microscope controller 214 is equipped with Peak Force Tapping® mode capability, as described for instance in U.S. Pat. No. 10,845,382.

The controller 214 also controls a frequency and wavelength tunable light source 216. Light source 216 may provide a wide range of wavelengths from the UV to the far-infrared. In one embodiment source 216 provides infrared radiation (IR) that matches the vibrational resonances of molecules in the material under test, i.e., sample 204. Laser 216, such as a quantum cascade laser (e.g., MIRcat, Daylight Photonics) or an optical parametric oscillator (OPO), delivers laser pulses 218 at a frequency dictated by controller 214. The light beam 222 is focused onto the tip-sample region, i.e., the tip-sample interaction area, via a focusing element 220, e.g., a 25 mm focus length off-axis parabolic, or any other optical focusing element such as a lens. Resulting spatial scans 224 at different wavelengths (λ₁, λ₂, λ₃) and wavelength-dependent nanoscale localized spectra 226 indicative of IR absorption are processed and displayed on a screen of a workstation or saved as data by controller 214 or a workstation. Such IR imaging data can be obtained before, after or during acquisition of other sample property data, e.g., mechanical (modulus, adhesion), electrical (surface potential or currents in KPFM or TUNA) or other measurements that can be provided together with the AFM operational mode of PFT.

Preferably, the relative position between the focus of the infrared beam 222 and the tip 203 is constant during IR data acquisition, i.e., the optical alignment to the tip is unchanged during IR absorption mapping across the sample and during point spectroscopy at a fixed sample location. This ensures that during an IR scan of the surface at a single IR wavelength the light intensity at the probe-sample interaction region where surface modification occurs is constant so that the surface response to the IR light can be quantitatively compared at different locations.

In a different embodiment the IR laser spot may be much larger than the AFM scan area so that light intensity variations while scanning the probe relative to the IR illuminated spot may stay sufficiently constant during scanning, e.g., within 10%. As a result, IR data at different positions of probe 201 are only accurate to within 10% in this example since the laser power varies. In another embodiment the described effect of relative motion between probe and IR illumination area can be compensated. One way is to follow the probe position with the IR illumination spot during scanning. Another is to measure the spatial variation of the IR signal on a sample with a homogeneous IR response. Once the 3-dimensional PFIR response is acquired for different xyz positions of probe 201 with respect to the IR illumination spot while the probe is in contact with the sample, measurements on other samples can be corrected for the spatial IR light variation.

Controller 214 contains a frequency generator to pulse laser source 216. A QCL for instance allows pulsing that follows an applied TTL signal. Alternatively, the IR pulses can be selected within the laser output beam 222 via optical means, e.g., by an acousto-optical modulator, electro-optical modulator, or a Pockels cell. A mechanical pulse picker (chopper) or rotating mirror can also allow only selected pulses to pass towards the tip while blocking unwanted pulses. It is understood that these elements may be inserted in the IR output of the IR light source, or they can be part of the IR light generation process within the laser system itself. In that case, for example, a Pockels cell may serve as a pulse selector to select the pump-laser pulses in an optical parametric oscillator or amplifier that drive the IR light generating process. What matters in the end is that the tip 203 is irradiated with laser pulses at a pulse repetition rate controlled by controller 214. The IR light beam 222 is linearly polarized along the tip 203 resulting in field enhancement at the apex of the typically conductive or metal-coated (e.g., PtIr, Pt, or Au) tip 203, a similar experimental condition as known for TERS or s-SNOM. Nonconductive tips and vertical light polarization with respect to tip 203 result in reduced signal.

In PFT, the vertical position of sample 204 on a stage 206 may be sinusoidally modulated with an appropriate drive signal provided by a controller 214 at a low frequency of several kilohertz, substantially (i.e., at least a factor of 5×) below the cantilever resonance frequency. The probe 201 may then be stationary. Of course, alternatively, probe 201 may be sinusoidally modulated in its vertical position, e.g., using piezo 208 (or an equivalent drive that employs a magnetic, electrostatic, thermal or optical force onto the cantilever to drive it). In essence, a relative oscillation between the probe and sample is what is required. Assuming a sample oscillation only, around the upper turning point of the oscillation, the sample is in controlled contact with the typically 1-50 nm-scale radius of the apex of tip 203 of probe 201. The maximum deflection of the cantilever during contact, hence, the peak force, is used as the set point of the feedback by controller 214 to maintain the average distance between sample 204 and tip 203. The mechanical properties of, for example, modulus, dissipation and adhesion can be extracted in PFT by analyzing the time-varying trace of the vertical deflection of the cantilever as recorded with the deflection sensor 212.

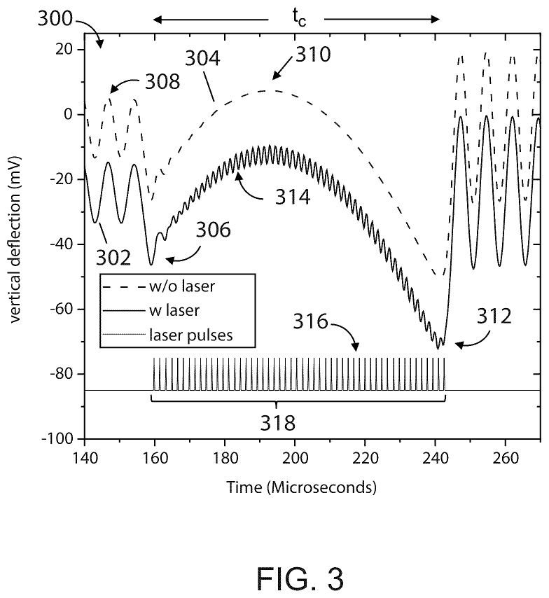

FIG. 3 illustrates the tip vertical deflection data 300 as a function of time in a Peak Force Tapping® (PFT) cycle in a preferred embodiment. In this example, the vertical deflection is given with perturbation from the IR laser pulses (deflection 302) and without perturbation, i.e., with the IR laser not pulsed during the contact time, or IR-unpulsed (deflection 304—dashed curve, vertically offset for clarity). During the PFT cycle the probe approaches the sample and snaps into contact with it at the snap-in-contact time 306, here at around 160 microseconds. Any free-space oscillation 308 of the cantilever that existed before this snap-in-time is suppressed afterwards. Note, however, that the snap-in-contact can excite a cantilever oscillation at one of the cantilever's contact resonances. This is apparent in the one to two oscillation cycles in deflection 304 for the first ˜10 microseconds after the snap-in-contact point 306. After point 306, tip 203 and sample 204 continue to move relative to each other and the probe 201 and sample 204 are further approaching each other until a maximum force is reached at the peak force tapping control point 310, i.e., the point where the feedback keeps the force constant during the PFT cycles. The position of the feedback point is adjustable in software but preferably coincides with the maximum of the PFT deflection curve. The relative motion of tip and sample is then reversed and at the adhesion point 312 (here at around 240 microseconds) the tip lifts off the surface, an event that may lead again to strong free-space oscillations of the cantilever (at 245-270 microseconds) that decay until the probe contacts the sample surface again in the subsequent PFT cycle. In the given example the laser pulses 316 were only present during the probe-sample interaction cycle or contact time t_{c}. i.e., the time interval (160-240 microseconds) where the tip is in contact with the sample during the PFT cycle, which is the time between the snap-in-contact time 306 and the adhesion point 312. The time marker relative to which the start and end of the IR pulse train is set may be the peak force tapping control point 310, or less preferably as discussed below the snap-in-contact point 306 or adhesion point 312, and a delay for the start of the laser may be added to shift the pulses accordingly into the contact time t_{c}. Note that the contact time is generally between 1 millisecond to a microsecond, depending on the Peak Force Tapping® operating frequency, and the pulse width of the IR laser is usually 1 picosecond to a few hundred nanoseconds.

In this example, a typical polymer sample such as PMMA or polystyrene (PS) induces several cantilever responses when the sample absorbs the IR laser radiation during laser pulsing. In general, a sample may be modified in several ways, depending on the material, e.g., the light induced effects can cause surface motion, charge accumulation/displacement and/or sample polarization that result in a mechanical or electromagnetic surface pulse force in response to the light. In case of PS the surface pulse force in the infrared stems from sample expansion when light is absorbed and most noticeably results in oscillations 314 of the cantilever, here, synchronously averaged for clarity over several PFT cycles. This oscillation can occur at a contact resonance of the cantilever and then the situation resembles a resonantly driven oscillator where the IR signal, i.e., the oscillation amplitude, is enhanced by the q-factor of the contact resonance mode. Note that the force during the PFT cycle varies so that both the contact resonance and the “Q” are expected to vary slightly over the PFT cycle. The described oscillation may also occur off-resonant with any cantilever mode, or an oscillation at a frequency f is induced while the laser repetition rate within the pulse train 316 is a fraction (1/n, with n=1, 2, 3 . . . integer number) of f, i.e., a lower resonant drive excites a higher harmonic that matches a contact resonance of the probe. This oscillation at its most pronounced laser-induced effect is then analyzed using a lock-in amplifier in the preferred embodiment, or other means such as an FFT block or boxcar-like signal integrator. Typically, the employed contact resonances lie in the 50-3000 kHz range with typical average laser powers used to excite the probe resonances of below 1 mW.

A lock-in amplifier here is a physical device and/or an algorithm that demodulates the response of a system at a reference frequency. Lock-in amplifiers may be electronic assemblies that comprise analog electronics, digital electronics, and combinations of the two. They may also be computational algorithms implemented on digital electronic devices like microprocessors, field programmable gate arrays (FPGAs), digital signal processors (DSPs), and personal computers. A lock-in amplifier analyzes an oscillatory system and outputs different signals, including amplitude, phase, in phase (X) and quadrature (Y) components or any combination of the above. The lock-in amplifier in this context can also produce such measurements at both the reference frequency and higher harmonics of the reference frequency.

In the preferred embodiment of the invention, the controller 214 would trigger laser emission in form of laser pulses 316 at a defined repetition rate fₗₐₛₑᵣ substantially during the contact time t_{c} of the PFT cycle with no emission outside this probe-sample interaction cycle. The peak force tapping control point 310 would serve as a synchronization point in the PFT cycle, relative to which a start and stop of laser pulsing would be chosen.

Detection of the laser-induced IR signal in the preferred embodiment relies on gated detection 318 based on a lock-in amplifier, boxcar-like signal integration, or similar technique. In lock-in detection the vertical deflection signal 302 with laser-induced deflection change 314 is demodulated at the reference frequency which is given by the laser repetition rate. The controller 214 that determines the laser repetition rate may have a built-in lock-in to which the reference frequency is provided. It is preferred to start data acquisition and lock-in demodulation at the start of the laser pulsing and end after the last laser pulse, i.e., to gate the acquisition and integrate the signal up to the contact time t_{c} or slightly below in order to avoid the actual events of snap-in-contact 306 and adhesion point 312. The contact time depends on the sample properties and the PFT operation settings. During imaging the operational PFT properties may stay mostly constant while the sample under the tip may change substantially in its mechanical properties (e.g., adhesion) so that t_{c} varies. In that case it may be beneficial to keep the gating length and position relative to the PFT cycle constant and smaller than the smallest t_{c} during the scanning at different sample locations. In this way, noise and instabilities of the PFT operation around the snap-in-contact time and the adhesion point may not compromise data acquisition. Data acquisition outside the contact time with a larger gating window or a continuously running lock-in over many PFT cycles adds noise to the signal of interest since the periods of time where the probe is detached from the sample carries no localized information from the tip-sample interaction region.

To increase the signal-to-noise ratio the acquired data can be averaged within a PFT cycle or between PFT cycles. Data averaging means summation or integration of the data output, e.g., from a lock-in amplifier, and normalizing by acquisition time or number of acquired analog-digital-converter (ADC) samples or number of PFT cycles. Averaging the data over more than one PFT cycle in the preferred embodiment requires averaging the phase sensitive output of the lock-in obtained during the gated detection windows. That means amplitude and phase output as obtained from each PFT cycle are averaged as complex values with the next PFT cycles. This is in contrast to averaging the amplitude output only while disregarding phase information. In phase sensitive averaging the noise in the signal is lower since for instance two complex values—representing noise—of the same amplitude but opposite phase can cancel each other when summed while the sum of their amplitudes cannot cancel. So in this example noise is suppressed in the first case but not in the second one. If increased noise and an elevated baseline/offset is acceptable, phase-insensitive averaging of amplitudes is also possible in one embodiment.

As mentioned above, the laser pulsing and detection are preferably limited to the probe-sample interaction cycle. The start and end of the detection and pulsing windows could be chosen relative to the peak force control point 310 by the user to restrict pulsing 316 to within the boundaries given by the snap-in-contact point 306 and adhesion point 312. Instead of point 310 the synchronization point can also be the snap-in-contact 306 or adhesion point 312. Note however, that the latter two vary depending on the sample, the tapping amplitude, the peak force and other effects so that the peak force tapping control point 310 is preferred. Since the contact time t_{c} varies with the aforementioned effects and especially the sample location, it may be beneficial to adjust the window length of laser pulsing dynamically based on the measured points 306 and 312. Alternatively, the length of pulsing may be calculated from the scan parameters (such as peak force), or it may be kept constant to always stay within points 306 and 312 during scanning. Note that a larger window for laser pulsing than t_{c} is acceptable, and continuous pulsing over all PFT cycles works as well as discussed. Limiting the pulsing to only during the contact time though, reduces sample heating and unwanted effects such as inducing free oscillations of the cantilever once the probe has lifted off the surface after the adhesion point 312. Gating detection only during the contact time improves the signal-to-noise ratio since otherwise only noise or artifacts during the absence of tip-sample contact would enter the detection channel outside tc.

In PFIR a long tip-sample contact time is preferred for increased duty cycle and hence increased signal-to-noise ratio while the tip still needs to be able to leave the surface without sticking to it. The contact time is controlled by the PFT tapping amplitude that is usually in the 30-150 nm range for PFIR.

Other features, less pronounced in this example of vertical deflection data 300, may also serve as signals indicative of IR absorption or an IR induced surface pulse force. Besides the aforementioned strong oscillations in the deflection trace, here vertical but in general vertical and/or horizontal, the IR laser absorption may lead to changes of the mechanical properties of the sample. This can result for instance in a shift of the adhesion point 312 both in time (to a later or earlier point in time) and/or in magnitude (i.e., to higher/lower deflection values). The same applies to the snap-in-contact time 306 or the slope between force maximum (overlapping with the peak force setpoint 310 in the FIG. 3 example data 300) and adhesion point 312 which would be indicative of a modulus change. The free space oscillations 308 may also be modified as a consequence of the IR induced surface pulse force that may result from sample expansion or retraction. That can include a change of the amplitude, frequency or the phase compared to IR un-pulsed PFT cycles. Such change compared to the IR un-pulsed trace may persist for hundreds of microseconds after the IR pulses, until the next probe-sample interaction stops the free-space cantilever oscillation at the snap-in-contact time 306.

Other samples, especially inorganic ones, may show different PFIR signal generation processes than mechanical probe-sample forces from surface expansion or retraction or shock waves. Inorganic materials with low thermal expansion coefficient may show electromagnetic probe-sample forces, e.g., from IR light induced charge accumulation, displacement or polarization. An example would be graphene that supports surface plasmons or local collective charge oscillations in the IR and to which the IR light can efficiently couple with momentum provided by the probe tip 203 (similar to s-SNOM). Surface and bulk plasmons may be detected in PFIR via the associated electromagnetic probe-sample forces. Similar forces could be expected for other quasi-particle excitations such as phonon-polaritons in boron nitride.

Note that the preferred embodiment does not use un-pulsed PFT cycles but every cycle is exposed to IR laser pulses to maximize the duty cycle and signal-to-noise ratio. Other sample properties derived during PFT operation such as electrical (current or surface potential) or nano-mechanical ones (adhesion, modulus) may be acquired during laser illumination. Crosstalk or interference between the measurements of IR absorption and for instance the modulus may occur, e.g., by sample softening and melting under IR irradiation. In that case it is beneficial to separate the PFT cycles that are used for extraction of IR absorption from those used for other properties, e.g., by not pulsing the IR laser during acquisition of nano-mechanical data and not extracting such data during IR absorption measurements. Such separation could occur within a scan line in imaging, or alternating between scan lines, between trace and retrace lines, or alternating between PFT cycles. Even within a single PFT cycle the laser pulsing and signal detection may be separated from the extraction of nano-mechanical data, e.g., IR absorption may be obtained in the first half of the PFT probe-sample interaction cycle and modulus data in the second.

There may also occur interference between the laser induced oscillations and the PFT force feedback mechanism necessary to ensure stable AFM operation. To prevent this, in a preferred embodiment the force feedback at the peak force tapping control at point 310 is based on a low-pass filtered deflection signal. For instance, a low-pass filter at 40 kHz suppresses the laser-induced deflection oscillation on an absorbing sample for laser pulsing at one of the contact resonances in the 100s of kHz to a few MHz range. On the other hand the low-pass filter needs to transmit lower-frequency deflection changes to allow the feedback to maintain a constant peak force setpoint during AFM operation during sample scanning or stationary (e.g. while acquiring infrared absorption spectra). Without a low-pass filter, the peak force setpoint feedback is disturbed, causing an increase in peak force noise, height noise in topography and in general noise for any AFM mode that relies on stable AFM operation, including infrared absorption. Such low-pass filter may be removed if the interference is small, or when the peak force tapping feedback is only applied during un-pulsed PFT cycles. Or, alternatively, the time window around the peak force tapping control point 310 may be excluded from laser pulsing so that the AFM feedback is undisturbed.

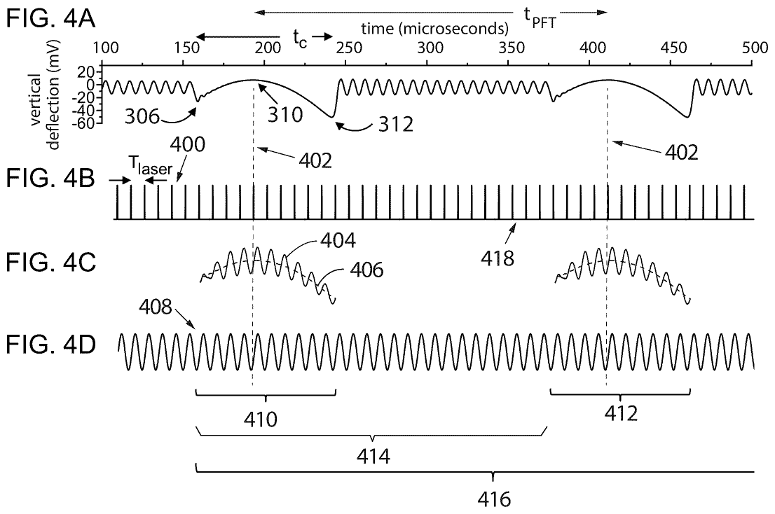

FIG. 4 illustrates an embodiment based on continuous laser pulsing. In this example two consecutive PFT cycles are shown. FIG. 4A gives the vertical deflection signal as a function of time for a f_{PFT}˜4.5 kHz PFT cycle where the tip is in contact with the sample for a contact time t_{c} of ˜80 microseconds for a total PFT cycle time of t_{PFT}˜220 microseconds.

FIG. 4B shows the laser pulses 400 that are running continuously at a well-defined repetition rate fₗₐₛₑᵣ=1/Tₗₐₛₑᵣ. The pulses are synchronized to the PFT cycle, i.e., each laser pulse occurs at the same relative point in time in the PFT cycle. For instance, vertical markers 402 for the two consecutively shown PFT cycles overlap with the peak force tapping control point 310 in each cycle. This point 310 may serve as a defined time marker within the PFT cycle and it is synchronized to the relative PFT motion between cantilever and sample, i.e., for a sinusoidal PFT motion the maxima of the PFT oscillation occur at a fixed phase or time delay relative to the peak force tapping control point 310. The snap-in-contact time 306 or adhesion point 312 are less suited as time stamps since they change dynamically relative to point 310 and hence the PFT motion. This dynamic change is based on sample properties and AFM operation, and points 306 and 312 would need to be derived from a measurement. The markers 402 indicate that the laser pulses 400 are synchronized to the PFT cycles and in the given example there is always a laser pulse overlapping with the peak force tapping control point. In other words the laser repetition rate fₗₐₛₑᵣ is an even integer multiple of the peak force tapping frequency, i.e., fₗₐₛₑᵣ=n*f_{PFT} with n=even integer.

In a typical example the PFT frequency can be fPFT=2 kHz and the laser repetition rate could be fₗₐₛₑᵣ=1300 kHz or 1302 kHz or 1304 kHz. The laser pulse repetition rate and the PFT frequency are synchronized, e.g., by sharing a common clock. As described before in FIG. 3 the laser pulses will cause an IR induced mechanical or electromagnetic surface pulse force that may result from a surface motion (sample expansion or retraction), a charge accumulation/displacement and/or a sample polarization. Such forces cause an oscillation 404 (in an otherwise undisturbed tip deflection 406) as highlighted in FIG. 4C. Here, only the deflection during the contact time t_{c} or probe-sample interaction cycle is shown since this is the time window of interest. For illustration purposes the frequency of the oscillation and its amplitude is exaggerated. For times outside the contact time the laser will not excite a large oscillation of the cantilever unless a free-space resonance of the cantilever is nearby, as discussed later. Note that the synchronization of the laser pulse repetition rate to the PFT cycle frequency as discussed above leads to oscillations in the tip deflection during the contact time that are also now synchronized to the PFT cycle. That means, as indicated by the vertical markers 402, the minima and maxima of the laser induced oscillations occur at the same point in time within the PFT cycles compared to a reference point such as the peak force tapping control point 310.

FIG. 4D gives a lock-in reference signal 408. This reference signal is synchronized to the laser repetition rate since both originate from controller 214. In one embodiment the lock-in amplifier is gated and only demodulates the laser induced signal during the probe-sample interaction cycle as indicated by the time window 410. Such gating of the lock-in operation can be triggered relative to a time marker in each PFT cycle such as the peak force tapping control point 310 as described above. Such lock-in based signal demodulation is repeated for the following PFT cycles, exemplified in window 412 for the next PFT cycle. The amplitude and phase (or in-phase and quadrature components) obtained with the lock-in amplifier for each cycle can then be averaged as complex values between consecutive cycles as described before. In another embodiment the lock-in demodulates during the entire PFT cycle time t_{PFT}, e.g., from 150 to 370 microseconds, as illustrated at 414. The drawback of this method is that the lock-in demodulates a deflection signal that contains only noise during the parts of the PFT cycle where the tip is not in contact with the sample. This additional noise added to the true signal that is only present during the contact time t_{c} reduces the overall signal-to-noise ratio in the laser induced signal. Furthermore, if the laser repetition rate is close to a free resonance of the cantilever (or it is at a fraction 1/n of the cantilever resonance with n=1, 2, 3 . . . integer, so that the cantilever resonance is close to a harmonic of the laser repetition rate), the cantilever will be driven from at least two possible effects: (1) the sample absorbs and the resulting surface pulse force leads to an acoustic wave (if the AFM is operated in air or other environment than vacuum) that may effectively drive the cantilever that is typically several micrometers to a few tens of micrometers above the surface in PFT. For instance, the tip 203 may be 3-18 micrometers long and the PFT amplitude may be 10-200 nm so that the cantilever overall is roughly 3-18 micrometers above the sample; and (2) another possible cause of an unwanted cantilever oscillation outside the in-contact-time t_{c} is coming from laser absorption of the cantilever material or its coating. In either case, the resulting cantilever oscillation may lead to a significant laser-induced signal that is not coming from a localized surface pulse force directly under the tip but could be an artifact from cantilever absorption independent of any sample characteristics, or it can be sample specific but originating from a large area of the sample, non-local and away from the tip. Such a non-localized artifact is not the desired, laser-induced signal of interest from the tip-sample area.

In summary, it is preferred not to detect outside of the probe-sample interaction cycle. This can be achieved by gated lock-in detection only during t_{c}. Alternatively, laser pulsing may be limited or gated to only occur during t_{c} as described before. In that case the lock-in may still demodulate the signal over the entire PFT cycle time t_{PFT} but due to the absence of laser pulses outside the contact time t_{c}, no acoustic effect or cantilever absorption drives a cantilever mode. The lock-in amplifier demodulates continuously over several PFT cycles 416 until the desired integration time is achieved. However, in that case, the lock-in may still see a strong unwanted signal if the free oscillation 308 (FIG. 3) is close to the lock-in reference frequency that is the laser repetition rate. Gated laser pulsing, i.e., pulsing only during t_{c}, and gated lock-in detection, i.e., lock-in signal demodulation only during t_{c}, are hence preferred with several benefits: noise or signals from artifacts such as acoustic effects or cantilever absorption when the cantilever is not in contact with the sample are not entering the signal demodulation and hence do not decrease the signal-to-noise ratio. Additionally, less laser pulses on the sample means less sample heating which may be beneficial for some samples such as biological or polymeric ones.

Since in this embodiment the oscillations 404 between consecutive PFT deflection traces are synchronized with a fixed phase change of zero, the deflection traces, e.g., of PFT cycle 1 and 2, or 1-4, etc., can be averaged synchronously in the time-domain before further processing to extract the laser-induced sample response. Time stamps or markers such as the peak force tapping control point 310 serve as synchronization point in time relative to which the deflection traces are averaged. Such averaging increases the signal-to-noise ratio before the oscillation is analyzed to extract, e.g., the IR absorption of the sample that caused the deflection oscillation. When a lock-in is used on this averaged time-domain data, usually the lock-in amplitude represents the IR absorption signal but other channels such as phase or the in-phase and quadrature components can also indicate IR absorption.

In another embodiment the laser pulses 400 are triggered by an event within each PFT cycle. A time stamp/marker such as the peak force tapping control point 310 within each PFT cycle may serve as a trigger to release after an adjustable positive or negative time delay a certain number of laser pulses within a pulse train. During that laser emission the pulses within the pulse train are defined by a constant laser repetition rate fₗₐₛₑᵣ. In such operation the laser pulse emission is triggered in a first PFT cycle and substantially overlaps with the contact time t_{c} of that first cycle (e.g., at time 160 to 375 microseconds in FIG. 4A), or is limited entirely to t_{c} for a gated laser pulse emission (e.g., during time 160 to 240 microseconds). The time stamp/marker of a second PFT cycle would then trigger the next train of laser pulses that may start such that at point 418 the time delay between the last laser pulse triggered by the first PFT cycle and the first laser pulse in the train triggered by the second PFT cycle are separated by the laser pulse period Tₗₐₛₑᵣ, i.e., the two separate pulse trains triggered by the first and second PFT cycle resemble a continuous pulse train with an equidistant time delay Tₗₐₛₑᵣ between all pulses.

Alternatively, at point 418 the time delay between the last and first pulse of the pulse trains of the first and the second PFT cycle, respectively, may be larger or smaller than the laser pulse period Tₗₐₛₑᵣ. However, the oscillations 404 in the deflection would still show no phase delay between different PFT cycles since the laser pulses are still synchronized to each PFT cycle. Deflection signals can still be averaged in the time-domain due to such synchronization and lock-in and other extraction methods can operate on the averaged data. Since at any given time the phase difference between the reference oscillation 408 and the laser-induced deflection oscillations 404 is constant, a lock-in amplifier or boxcar-like signal integrator can also run continuously on real-time data and average over multiple cycles, even if there are discontinuities 418.

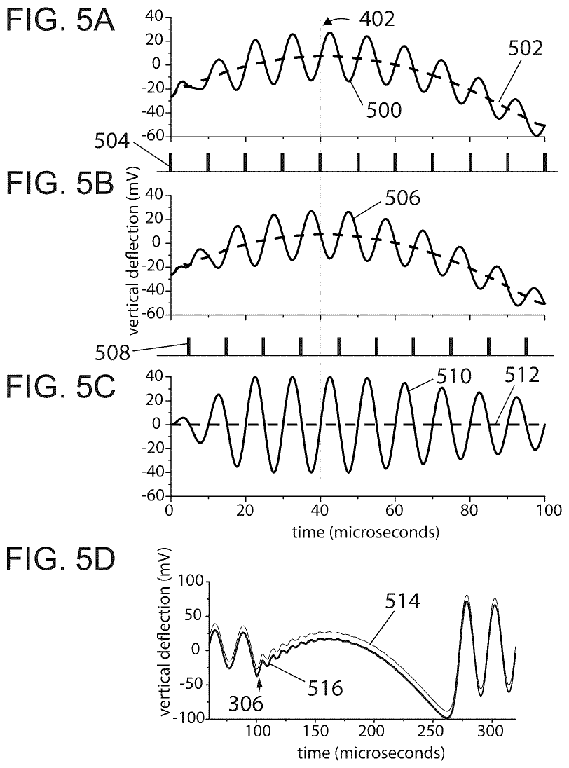

In FIG. 5 another embodiment of the invention is demonstrated based on the vertical deflection signal in PFT during the contact time t_{c}. FIG. 5A depicts a similar situation as in FIG. 4: the shown PFT vertical deflection trace that would look like 502 without laser illumination reveals distinct oscillations 500 when driven with laser pulses 504. Specifically, for the shown PFT cycle a vertical time marker 402 is shown that overlaps with a laser pulse in 504. In contrast, FIG. 5B illustrates the situation for a laser pulsing 508 where the pulses are offset by half of the time period between laser pulses, i.e., marker 402 does not overlap with a laser pulse now but is centered between pulses in 508. In other words the pulse trains 504 in FIG. 5A and 508 in FIG. 5B exhibit a 180-degree phase shift between them. This phase shift translates to a 180-degree phase shift in the laser-induced oscillation 506 compared to 500. Such a phase shift is not observed in FIG. 4 where the oscillations within all PFT cycles are synchronized to a defined point in time within each PFT cycle, e.g., the peak force tapping control point 310. In the embodiment of FIG. 5, however, the laser pulse repetition rate is such that the oscillation between consecutive PFT cycles has flipped phase by 180 degrees. The laser-induced real-time signal extraction methods described before in reference to FIGS. 3 and 4 are still valid, i.e., ungated or gated lock-in demodulation, or boxcar integration, for gated or ungated laser pulsing applies also in FIG. 5.

However, signal averaging in the time-domain is now different. Synchronously adding consecutive pulses in the time domain for subsequent extraction of the laser-induced sample response in the vertical or horizontal cantilever deflection would result in cancelation of the oscillations since the laser-induced oscillations in consecutive PFT cycles 500 and 506, respectively, are perfectly out of phase. In this case the subtraction of two (2) consecutive PFT deflection traces is required. FIG. 5C shows such an operation, i.e., subtraction of trace 506 from 500 leads to trace 510, denoted as sub 1-2. Notably the amplitude of the oscillation 510 has doubled after this subtraction procedure and the slowly varying PFT deflection trace 502 has canceled out, i.e., without laser irradiation a background 512 would result around zero deflection. That means this operation effectively removes the slowly varying PFT deflection signal. Such slowly varying signal 502 can add noise in the data extraction methods if the frequency of the slowly varying deflection is sufficiently close to the laser pulse repetition rate. Previous methods to remove this slowly varying signal include the subtraction of consecutive PFT deflection traces between a pulsed and an un-pulsed PFT cycle, which means a reduction in duty cycle. The embodiment shown in FIG. 5 does not rely on un-pulsed PFT cycles and because of that an improvement in signal-to-noise ratio by sqrt(2) is expected from this 2× higher duty cycle when subjecting every PFT cycle to laser pulses compared to only every second one, as in some prior art. Another known method to remove the slowly varying curvature 502 of the PFT cantilever deflection is the fitting with a polynomial function and subsequent subtraction (H. Wang et al., Anal. Chem. 93, 3567 (2021)). Drawbacks of this fitting method are that a real-time fit may be computationally costly and it is only an approximation while the embodiment of FIG. 5 removes the measured (not fitted) background in a simple subtraction process. After using the described method to arrive at the subtracted signal 510, the curve is further processed, e.g., using lock-in, or boxcar based methods to extract the laser induced signal strength. An FFT algorithm can also be employed on this time-domain data: an integral of the spectral amplitude around the laser repetition rate, possibly also around the higher harmonics of the laser repetition rate, or the average of fundamental and harmonics, would serve as laser induced sample response signal, for instance indicative of IR absorption.

Based on FIG. 5D the benefit of the differential method of subtraction of PFT cycles is discussed with respect to the suppression of artifacts and noise. Random noise superimposed on the deflection signal cancels partially when subtracting consecutive PFT cycles. Artifacts that are synchronized to the PFT cycle are also reduced. FIG. 5D shows a measured deflection without laser irradiation. In a single deflection trace 514 a pronounced oscillation is excited after the snap-in-contact time 306. That oscillation at a cantilever contact resonance decays in amplitude. Averaging 4800 PFT cycles show in 516 that these oscillations are still present: they are synchronized so that they sum up coherently when averaging over thousands of cycles (note: 516 is offset vertically for clarity compared to 514). Such oscillation that is already present without laser irradiation may interfere with any laser-induced signal. This is especially the case if the frequencies are close together, or overlap, which may occur since both are contact resonances. Furthermore, higher harmonics of the oscillation caused by the rapid snap-in-contact can also overlap in frequency space with laser-induced changes. Since 516 shows that the artifact oscillations are perfectly coherent over many PFT cycles, the differential method described before removes these artifact oscillations and reduces their effect on the true laser-induced deflection changes.

In FIG. 5, a 180-degree phase shift between for instance consecutive PFT cycles was described. Such phase shift can be caused in continuous pulsing, or in gated pulsing. As an example, in continuous pulsing a pulsing frequency of 1301 kHz or 1303 kHz results in the 180-degree phase reversal in every second PFT cycle for a 2 kHz PFT frequency. At 1300 kHz or 1302 kHz no such reversal occurs, the deflection oscillations would be in phase between PFT cycles. In general, for a 180-degree phase shift to occur between consecutive PFT cycles, the laser pulsing frequency needs to be an integer multiple of the PFT frequency plus or minus half of the PFT frequency, i.e., fₗₐₛₑᵣ=(n±1/2)*f_{PFT}, with n=1, 2, 3 etc. In gated pulsing a time delay of half a laser pulse period before the start of the pulse train may be introduced between a first and a second PFT cycle. This results in the 180-degree phase shift between the two cycles and can then be repeated for following cycles. Delaying by 1.5, 2.5, 3.5 etc. times the laser pulse period also works. However, the oscillations of the 1^{st} PFT cycle have no corresponding 180-degree shifted oscillations of the 2nd cycle until laser pulsing starts in the 2nd cycle. That leads to an abrupt change in amplitude of the resulting oscillation after subtraction, and additionally a reduced duty cycle from using less laser pulses.

While the procedure in FIG. 5 was described based on a 180-degree phase shift of laser pulses between two consecutive PFT cycles, other embodiments can be deduced in a straightforward way. For instance, such phase shift can be set to occur between PFT cycle 1 and 3. In that case the oscillations 506 and 500 between cycles 1 and 3 are out of phase by 180 degree and can be subtracted to arrive at sub₁₋₃ where the slowly varying baseline is again removed. The same applies to cycles 2 and 4 then which can be subtracted accordingly to sub₂₋₄. The resulting curves sub₁₋₃ and sub₂₋₄ etc. may then be averaged synchronously, or the laser-induced data extraction is applied to sub₁₋₃ and sub₂₋₄ etc. separately and the results are averaged. In this example the phase shift of the laser induced oscillations 500 or 506 between consecutive PFT cycles would not have changed by 180 degrees but by 90 degrees (or 270 degrees etc., i.e., more generally by n*90 degrees with n=1, 3, 5 . . . . odd integer). If the oscillations of cycle 1 and 3 are out of phase by 180 degree, the same will apply to cycles 1 and 5 or 1 and 7, of course, since the two involved frequencies of PFT frequency and laser repetition frequency are fixed in the preferred embodiment. Hence, other background removal combinations can be employed. Note however that for imaging with its time-dependent change in XY sample location it is preferred to combine and average only such PFT cycles that are close together in time so that the deduced signal from the laser induced sample modification (e.g., absorption) can be attributed to a small number of spatial XY pixels. Otherwise, the spatial resolution of the laser-induced sample modification is poor. For instance, if the typical PFIR line scan rate is 1 Hz, a 256 pixel line corresponds to ˜2 ms per pixel for trace and ˜2 ms for retrace. Typically, only trace or retrace is recorded so that the 2 ms is the maximum time over which PFT cycles should be averaged without starting to average over multiple spatial pixels. If the PFT frequency is 2 kHz, only 4 PFT cycles would occur during the 2 ms pixel time.

While in imaging it may be desired to not average over too many spatial pixels in order not to decrease the spatial resolution below a desired minimum of 2, 5 or 10 nm, a similar problem occurs in nanospectroscopy at a fixed spatial location. In spectroscopy the laser wavelength is swept and the sample response is recorded to arrive at a wavelength-dependent sample response curve such as a nano IR absorption spectrum. That means that the wavelength is kept constant for a certain small time, e.g., 10 ms for a 1000 cm−1 wide sweep within 5 seconds at 2 cm−1 resolution. If the averaging time to extract the laser-induced sample response is much larger than 10 ms, the spectral resolution is degraded since now data is averaged over several wavelengths.

The cases in FIGS. 4 and 5 describe embodiments where the phase of the laser-induced oscillation within the contact time t_{c} of the PFT cycle is constant between consecutive PFT cycles (FIG. 4) or shifted by 180-degrees (FIG. 5). In a more general implementation this phase change between consecutive probe-sample interaction cycles may read neither 0 nor 180 degrees. In that case, only PFT cycles further away from each other exhibit a close to 180-degree phase change in the deflection oscillations that then allows the subtraction shown in FIG. 5C with a substantially flat, i.e., zero, background 512 and substantially constructive interference 510 of the two chosen deflection traces. Since the PFT cycles are now further away from each other, averaging over multiple spatial pixels in imaging or spectral steps in nanoscale spectroscopy would become an issue and reduces the spatial or spectral resolution. Here, lock-in demodulation or boxcar-like signal integration based on individual PFT deflection traces such as 404 in FIG. 4 during the contact time t_{c} when gated, or during the whole PFT cycle 414 when ungated is preferred. That means phase-sensitive averaging can be applied between the data from individual PFT cycles, or lock-in demodulation or boxcar-like signal integration occurs continuously over multiple cycles until the desired integration time is reached.

Note that in such operational mode the laser repetition rate is not synchronized to the PFT cycle frequency. For continuous pulsing, gating the signal extraction is preferred and the gated extraction windows need to overlap with the probe-sample interaction cycles for highest duty cycle and hence signal-to-noise ratio. In another implementation the laser pulses can be gated for continuous or gated signal extraction. In one such embodiment the laser receives a TTL signal at the reference frequency of the lock-in or boxcar integrator, but this TTL signal only occurs during the tip-sample interaction cycle. This causes the laser to emit pulses synchronized to the reference frequency while limiting the train of pulses to the tip-sample interaction cycles. Lock-in amplifier or boxcar-like signal integration can then occur continuously over several PFT cycles, e.g. for an integration time of 10 ms averaging over 20 PFT cycles for a 2 kHz PFT frequency. Alternatively, signal extraction is also gated and limited to the probe-sample interaction cycles.

Gating the detection may also be achieved by continuously reading out the data for a lock-in amplifier, for instance, and selecting in the controller 214 which data to keep and which data to discard. Furthermore, the deflection data that enters the lock-in or FFT or boxcar-like detection can be exchanged partially for data that does not increase noise for continuous detection. As an example, a lock-in integrating over the time window 414 would normally include noise from the time interval 250-375 microseconds in FIG. 4 where the tip has already left the surface. To prevent this, the deflection data in that range could be replaced with a suitable constant value, e.g., the average of the lock-in output within the window 410. In that case, averaging over signal 414 instead of signal 410 only would not change the lock-in reading in neither value nor noise. Similar approaches can be done for other extraction methods, e.g. an FFT algorithm may operate on the subtracted deflection data 510 in FIG. 5 where the deflection beyond the probe-sample interaction cycle has been filled with zeros. However, in case of an FFT it may be preferred to reduce the number of data points for which the FFT algorithm is executed in order to save computation time. This would again favor gated signal extraction only during the contact time.

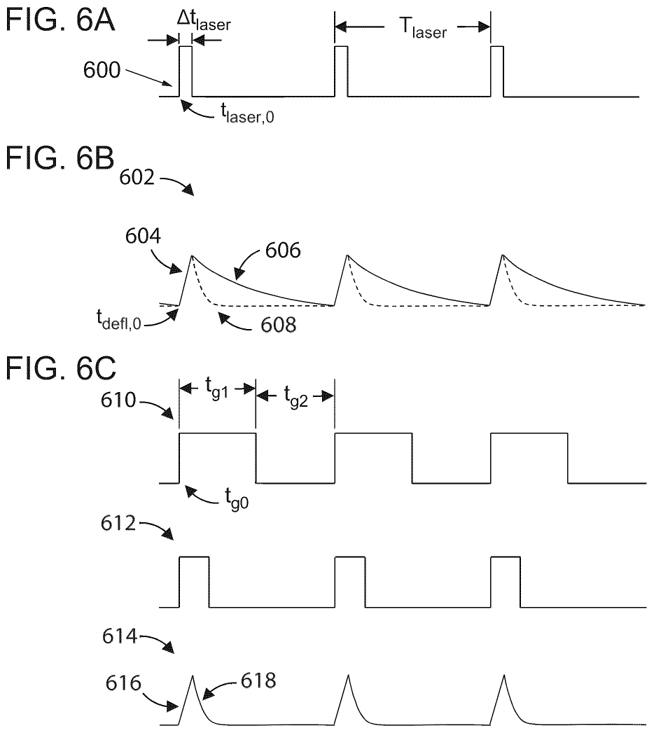

While in the above description the laser-induced signal was illustrated in form of an oscillation in the deflection channel, more complicated signal shapes are possible. They are described in FIG. 6 together with more optimized signal extraction methods for best signal-to-noise ratios. FIG. 6A shows a typical laser pulse train 600 with a laser pulse starting at time t_{laser,0} with a pulse length Δtₗₐₛₑᵣ and a period Tₗₐₛₑᵣ. Typical values for Δtₗₐₛₑᵣ and fₗₐₛₑᵣ=1/Tₗₐₛₑᵣ are 1 picoseconds to 1 microsecond and 50-3000 kHz, respectively. Note that the rectangular shape of the laser pulse is an approximation and other rising and falling edges are possible.

In FIG. 6B the laser induced deflection trace 602 during the in-contact time t_{c} is shown, but after subtraction of the slowly varying in-contact PFT deflection. In this picture, no laser excitation would result in a flat line. During the laser pulse Δtₗₐₛₑᵣ the sample for instance absorbs and expands which may lead to a linear change 604 in time in the deflection signal. That change may typically start with the laser pulse itself, i.e. t_{defl,0})=t_{laser,0}. Once the laser pulse ends, no more energy is deposited in the sample and thermal diffusion typically leads to sample cooling and a decrease in the deflection signal. Such decrease can follow an exponential decay 606 until the next laser pulse starts the heating and cooling cycle again. Depending on the time scales of Tₗₐₛₑᵣ and the sample relaxation time, given by the sample properties such as thickness and thermal coupling to a substrate, the sample may cool down between pulses close to the temperature it would show without any laser pulsing. Such a case is depicted in curve 608 that shows a fast exponential decay towards the ‘undisturbed’ sample temperature which is the same as if the sample was un-pulsed. If the cooling time was longer than Tₗₐₛₑᵣ the sample temperature and hence deflection change from sample absorption and thermal expansion would rise with the first laser pulses in a pulse train at the beginning of the PFT in-contact window. After the initial laser pulses an equilibrium would be reached in the sense that the sample temperature would cycle between a minimum and maximum temperature before and after each laser pulse, respectively, but the minimum and maximum temperature would be the same for the pulses within the pulse train, and not continue to rise. Hence, after the equilibrium has been established, the deflection baseline or offset would lie above the case for an un-pulsed PFT cycle, i.e., curve 602 would be offset vertically with a higher baseline and small deflection changes from laser pulsing on top. Depending on the sample's thermal properties, the laser repetition rate, its relation to the contact resonance frequencies of the probe, and the probe properties (e.g., its q-factor), laser pulsing can lead to other probe responses than 602 or the more pronounced oscillations of 314, e.g., a more gradual increase 604, even a decrease (step) 604 for a sample of negative thermal expansion, or a delay between start of the deflection change t_{def,0} and laser pulse start t_{laser,0}.

In FIG. 6C we turn to different detection methods apart from for instance the lock-in based detection described earlier. Curve 610 gives an example of a boxcar-like signal integration and averaging. At a time to the deflection signal may be integrated for a time t_{g1} while no integration happens during the dead time t_{g2}. In a preferred embodiment the method is applied to the deflection signal 602 after removal of the slowly-varying in-contact PFT deflection, obtained e.g., as described in FIG. 5 or by using un-pulsed PFT cycles as references for subtraction. In general, the approach also works on the raw PFT deflection as in 304. The start t_{g0} is chosen relative to the laser pulse t_{laser,0} such that the integration gate coincides with the signal of interest, here the deflection increase 604 and decay 606. When the gate is open in t_{g1} the integrator detects the signal while noise and interference is not detected when the gate is closed during t_{g2}. This corresponds to a multiplication of the input signal (i.e., deflection) with a boxcar function and integration over t_{g1}. Boxcar averaging then occurs over the gated integrations of many laser pulses before potential averaging with the next PFT cycles. Curve 612 gives an example of a narrower signal integration gate that may be more suitable for detection of the faster decaying curve 608. Otherwise, measuring continuously in time in that case would result in a low signal-to-noise ratio since the time intervals after 608 has decayed entirely contribute to the captured noise but carry no laser-induced signal. Note that in one preferred embodiment any integration or accumulation of signal is normalized by the acquisition time, number of laser pulses, or number of ADC samples that are integrated.

Other gating functions may even be more suited. Curve 614 illustrates such an optimized gating function: during a linear rise 616 the deflection signal is integrated but the result is weighted according to the gating function, i.e., the data point(s) obtained at and near the peak of the gating function carry most weight. The same applies to the for instance exponentially decaying part 618 of the gating or weighting function. Such a gating function may be tailored to the specific sample and excitation conditions (e.g., the laser pulse length) to optimize the rise time 616 and fall time 618 while minimizing integration of noise.

While lock-in amplifier and FFT based signal extraction require an equidistant period between laser pulses within the PFT probe-sample interaction cycle, i.e., a fixed laser repetition rate, the use of more general gating functions in boxcar-like integration allows for a non-equidistant pulsing. As long as the gating for boxcar integration substantially coincides with the presence of the laser-induced deflection change, the laser pulse distance can vary from laser pulse shot to laser pulse shot within the PFT probe-sample interaction cycle and between cycles. That implies that the gate lengths t_{g1} and t_{g2} of 610 may vary but they must still be synchronized to the laser pulses even when the period between pulses varies. Such pulsing scheme may be required for a light source where the timing of the light emission is not well controlled but where the emission time can be determined (e.g., via a photodiode) and can be used to trigger the boxcar-like detection.

Note that other methods to obtain a laser-induced signal from deflection curve 602 or a more oscillatory motion 314 or 510 exist, e.g., the rms of the signal can be determined, or a fit with sin or cos curves where the amplitude of the fitted curves represent the laser induced signal, or the minimum and maximum values of the oscillation amplitude can be read. A bandpass filter around the laser repetition rate, or a high-pass filter below it, may be applied also to the deflection signal before further data extraction.

The laser pulsing does not need to occur at a contact resonance of the probe when in contact with the sample. Pulsing can also occur off-resonance. Especially when pulsing continuously and detecting continuously it is beneficial to not excite and detect at the free cantilever resonance $2 or its higher mode at ˜6.3Ω, or at fractions 1/n (n=1, 2, 3 . . . integer) of these modes, in order not to drive them when the cantilever has lifted off the surface. After lift-off from the surface the cantilever may oscillate anyway at its free resonances, so detecting at these frequencies only adds to unwanted noise and background. In a specific implementation, the laser pulsing may occur at approximately twice the free cantilever resonance $2, i.e., at 2Ω. In that case, if the laser pulsing is continuous and not gated/limited to the PFT contact time, excitation at twice the free cantilever resonance does not excite the cantilever: even if it absorbed or was experiencing an acoustic wave from the sample, such a drive at 2Ω would ‘kick’ the $2 cantilever oscillation in-phase, then out-of-phase, and so on, effectively suppressing the oscillation. The cantilever however might still show the fundamental free resonance and higher harmonics after it left the surface after the adhesion point but they are not actively driven by the laser.

Note that if a contact resonance were chosen for laser pulsing, the contact resonance would shift in general with a change in the mechanical tip-sample interaction. This could be caused by a change in AFM parameters (such as peak force setpoint) or most commonly in the change of the nano-mechanical sample properties, especially during scanning of an inhomogeneous sample. This can lead to artifacts and ambiguities since e.g. a drop in IR signal on a sample area can be caused by less IR absorption or a modulus change that shifts the contact resonance. To compensate for that, frequency-tracking, e.g. via a phase-locked loop on the IR signal, is preferred, and is well compatible with a lock-in based signal treatment with its amplitude and phase channel. Such a tracking mechanism would adjust the laser repetition rate dynamically to overlap it with the contact resonance for instance. Alternatively, the effect of contact resonance shift can be minimized by operating off-resonant, i.e., by laser pulsing and detection away from a cantilever resonance where laser-induced signals are less sensitive to the mechanical tip-sample interaction.

Signal extraction from the deflection traces using a lock-in amplifier, a boxcar-like signal integrator, FFT or similar techniques may also occur at higher harmonics of the laser repetition frequency. When the cantilever during the PFT contact time is excited by the sample at the laser repetition rate, the deflection response 602 in FIG. 6B may be asymmetric and not a pure oscillation so that it carries higher harmonics of the fundamental in general. This can be helpful in an embodiment where the cantilever itself absorbs laser energy which leads to a non-localized laser-induced oscillation that competes with the oscillation generated by the localized surface pulse force from the tip-sample region. Such laser excited cantilever heating is typically associated with a nearly sinusoidal cantilever motion. Detecting at higher harmonics can then suppress the non-localized cantilever motion at the fundamental frequency and recover the localized signal from under the tip. The drawback of this method is the reduced signal strength at higher harmonics.

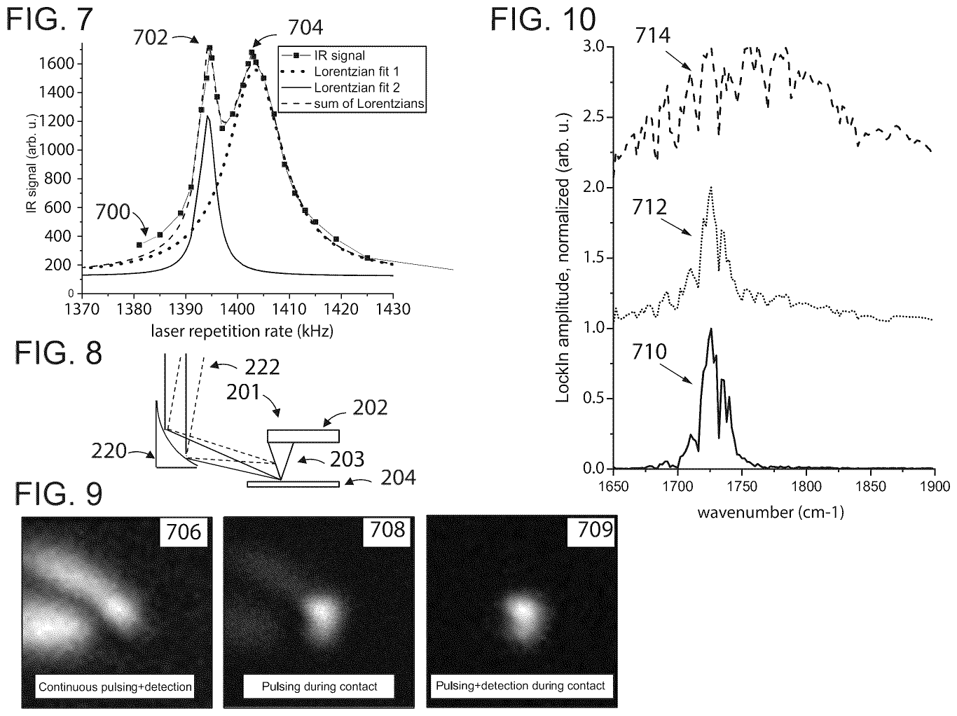

FIGS. 7-10 highlight an issue that can arise when laser pulsing and signal detection is not gated and limited to the PFT contact time t_{c}. i.e., but when the entire PFT cycle is evaluated and exposed to continuous pulsing. FIG. 7 illustrates the IR response 700 for continuous pulsing as obtained by a continuously operating lock-in amplifier. The IR wavelength was chosen as 1730 cm−1 to match the Carbonyl-absorption peak of the investigated PMMA film sample. While the IR laser repetition rate is tuned, the lock-in-extracted signal amplitude is recorded with signal maxima 702 and 704 at data points 1394.6 kHz and 1402.7 kHz. Note that although discrete points are shown at random frequencies, a continuous repetition rate sweep is possible with the system. The two peaks have been fitted with two Lorentzian curves. When withdrawing the tip from the sample by several hundred micrometers the broad peak disappears, and the narrow peak at 1394.6 kHz remains at the same frequency (Lorentzian fit 2). In a control experiment back in contact with the sample in PFT mode, the IR laser pulses are limited or gated to only the contact time t_{c}. In that case the narrow peak disappears and only the broader one remains as visualized with a fit (Lorentzian fit 1). This proves that the narrow peak is originating from a free resonance of the cantilever whereas the broad peak is stemming from the localized surface pulse force that the tip feels locally only when in contact with the sample. Only this broad peak contains the desired localized sample signal that is of interest when measuring a nanoscale IR absorption. The presence of the narrower free cantilever resonance may compromise the detection of the desired nano IR signal as discussed already previously. Here, we show more experimental evidence of the negative effect of continuous laser pulses and un-gated detection.

In FIG. 8 a setup is depicted to acquire intensity maps in FIG. 9 that are obtained during the alignment step in a nano IR instrument that precedes any IR absorption measurements. When installing a new AFM probe the IR laser beam focus from beam 222 needs to be realigned in the xyz coordinates to the new position of tip 203 on the sample 204 in order to be able to measure any IR signal from the tip-sample region. To this end, at first a visible alignment laser collinear with the IR beam is focused near the tip. Then the IR beam focus is scanned over the tip and an IR signal is recorded, showing a signal maximum only when the IR beam focus overlaps with the tip-sample region. The beam focus can be scanned by different means. One method is to scan the focusing element 220 such as an off-axis parabolic mirror or a lens in xyz while the IR signal is acquired. Another method is to scan the angle of the incoming IR beam 222.

The resulting intensity maps of such a signal search are displayed in FIG. 9. Continuous pulsing at the contact resonance 704 of ˜1403 kHz and continuous lock-in detection result in many signal maxima in 706 that are related to the cantilever shape. When only pulsing during the contact time t_{c}, such gating leads to a single bright spot in 708 that corresponds to the tip-sample position with much reduced but still present artifacts. The remaining artifacts are due to the un-gated detection that is still sensitive to the free-space oscillation 702 of the cantilever. As mentioned before these oscillations are excited after lift-off of the cantilever (even without any laser pulsing), and here their frequency is close to the detection frequency. In 709 the detection is additionally gated and the previous cantilever-related artifacts are absent. Clearly, the case 709 of pulsing and detecting only during contact is preferred for alignment: the optimal alignment of the laser beam focus to the tip-sample position is unambiguous, whereas for an ungated pulsing and detection the various signal maxima in image 706 obscure the optimal alignment and one may end up optimizing the wrong signal, e.g., optimizing the overlap of cantilever 202 (instead of the tip 203) with the beam focus.

FIG. 10 illustrates the different IR responses as function of the IR laser wavenumber for the different intensity maps of FIG. 9 in PFIR on a PMMA film sample. All curves are normalized to one (1) and shifted vertically for clarity. The bottom curve 710 shows the IR laser induced signal as obtained by a gated lock-in amplifier (i.e., limited to the probe-sample interaction cycle) demodulating the vertical deflection signal during gated laser pulsing. The extracted amplitude signal is proportional to the sample absorption and shows the carbonyl absorption peak around 1730 cm−1. Note that the presented signal is not normalized here by the laser power spectrum as usually required to obtain the nano IR absorption spectrum. Such a normalization by the laser background removes the effect of a non-constant laser power spectrum on the absorption signal, and it removes water lines. Note that dips in the lock-in amplitude signal 710, e.g., at 1716 cm−1 or 1732 cm−1, are due to water absorption in the IR beam path (which would cancel out if the signal was normalized by the laser power spectrum). Importantly this single absorption line 710 was obtained with the IR laser beam aligned to the single bright hotspot in 709 of FIG. 9. In contrast the curve 712 was obtained when pulsing and detecting continuously and when aligning the IR beam to the center of the image 706 in FIG. 9. Now, still a carbonyl-absorption is seen but superimposed on a broader background, i.e. the baseline is elevated. Spectra taken in the more defined hotspot in the center of 708 would lie in between the extreme cases of spectra 710 and 712 (not shown), i.e., with a small but elevated broader background. Depending on the chosen laser repetition rate, other hotspots or bright spots in image 706 of FIG. 9 (other than the center) may show signals resembling curve 714. No or only a small carbonyl resonance is visible but a broad background (with many water absorption lines). Curves 712 and 714 (continuous pulsing and detection) are caused by previously discussed effects: the cantilever is excited by its absorption of the IR radiation and/or an acoustic, long-range wave drives it that originates from sample absorption under the cantilever. In both cases the feature of interest in nano IR absorption, namely the absorption peak of the carbonyl resonance in this example, may be concealed or heavily contaminated by these artifacts.

Note that the effects seen in FIG. 7-10 are independent of the detection method, i.e., an FFT based signal extraction shows the same behavior as the lock-in based one, and the same applies to boxcar-like integration. The magnitude of the artifacts depends on the experimental conditions (e.g., the IR spot size) and the AFM probe properties. For instance, the free-space resonance frequency of the cantilever may not overlap much with a contact resonance for a different geometry of the cantilever. Or tip 203 may be spatially separated more from the cantilever 202 so that the IR spot does not overlap as much with the latter when the tip-sample region is excited. Or the contact time may be a larger fraction of the PFT cycle so that any artifacts originating from outside the contact time are less pronounced.

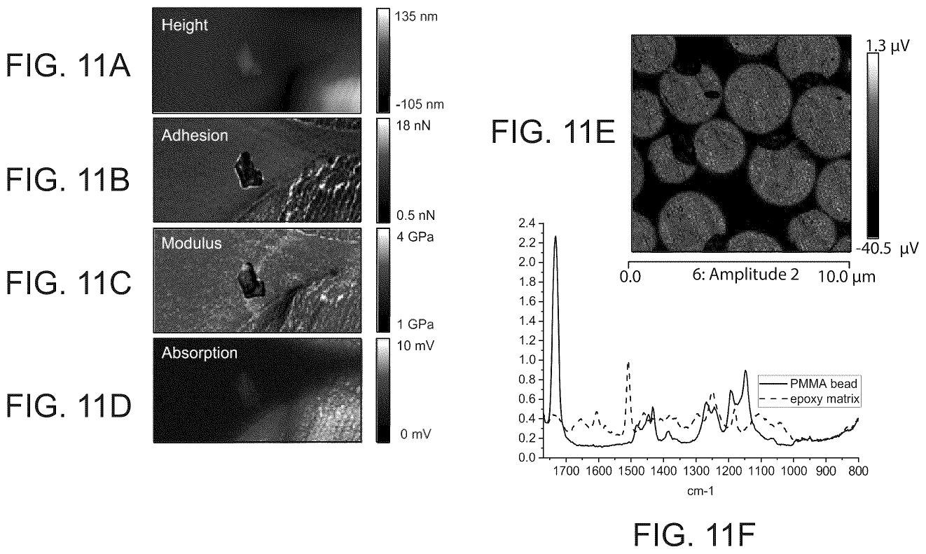

The method is truly a multimodal spectroscopy technique where IR and nano-mechanical data can be obtained simultaneously since both require PFT AFM operation. FIG. 11A-11D show the combination of PFIR with an adhesion and modulus measurement using gated IR pulsing and continuous lock-in based detection. In this embodiment the laser repetition rate was not chosen at a contact resonance but it was set to 662 kHz where the IR signal has dropped to 30% compared to the peak at 789 kHz. The benefit of this off-resonant drive is to minimize mechanical artifacts in the IR image that would result in higher imaging contrast and more imaging artifacts due to shifts of the contact resonance: at the chosen frequency away from a resonance peak the IR signal may be rather constant with frequency. Frequency tracking during scanning, e.g., based on a PLL, would follow those shifts but is not shown herein. The sample is a PMMA bead in epoxy, scanned in a 1.5 micrometer scan at 0.5 Hz with 512×128 pixels. All images were collected simultaneously, preventing thermal drifts that would appear during consecutive imaging. The height image in panel (a) shows a central feature that reveals less adhesion (b) and a smaller modulus (c) than the rest of the image. Panel (d) illustrates the IR absorption taken at 1730 cm−1. The PMMA bead lights up at the bottom right while the central feature is less bright.

FIG. 11E shows a larger scale IR scan of these PMMA beads within the epoxy matrix at a wavelength of 1730 cm−1 corresponding to the PMMA carbonyl absorption. The round absorbing PMMA beads light up within a non-absorbing matrix. The scan is taken at 0.5 Hz for 10 micrometer scan size at 512 pixels. A force of 1.5 nN was used with 30 nm PFT amplitude at a laser repetition rate of 1400 kHz at a contact resonance for a different probe having a 0.4 N/m spring constant. In this embodiment the laser pulsing and lock-in detection were limited to the contact time only within the PFT cycle. The lock-in was implemented inside an FPGA. The corresponding spectra for PMMA beads and epoxy matrix are shown in FIG. 11F. With a spectral resolution of 2 cm−1, ten (10) spectra were averaged, each taken for ten (10) seconds. As usual, to obtain the nano IR absorption from the wavelength-dependent tip response, the latter has been normalized by the laser output power that was measured with a power meter under similar experimental conditions. The setup was purged with dry air to remove water lines.

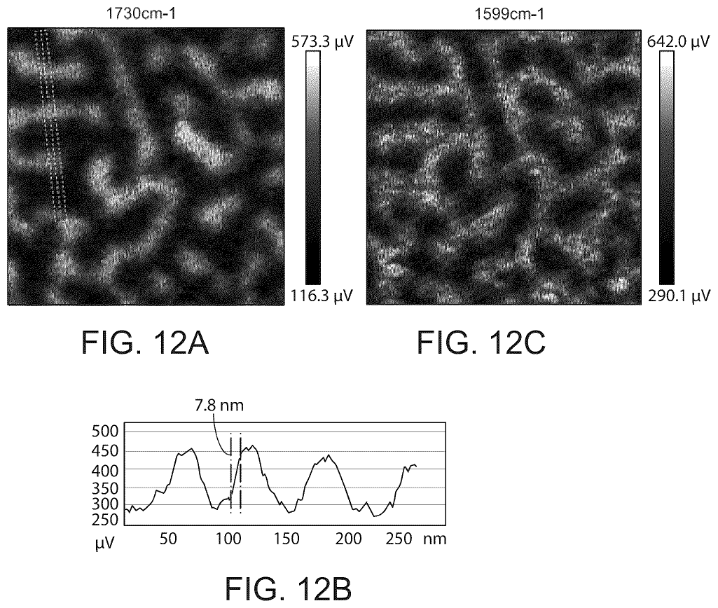

FIG. 12 highlights the spatial resolution achievable with the embodiment of the invention. A PS-b-PMMA block copolymer has been imaged visualizing the distribution of PMMA domains that absorb at 1730 cm−1 and PS domains that absorb at 1599 cm−1. The 400 nm scan size images were acquired at 1 Hz scan speed with 512×256 pixels, within a scan time of 5 min each. A 5 N/m spring constant probe was used at a PFT tapping amplitude of 30 nm and a PFT force setpoint of 3 nN, in the typical PFIR range of several 10s of pico-Newtons to several nano-Newtons. In FIG. 12A gated pulsing (close to the contact resonance around 961 kHz) during the contact time only and gated lock-in detection was employed, and a spatial IR resolution of <8 nm was demonstrated as seen in the linecut of FIG. 12B. In FIG. 12C an FFT readout routine was employed after subtracting the deflection of consecutive PFT cycles according to FIG. 5 to remove the slowly varying background and increase the signal-to-noise ratio. The laser repetition rate here was 961 kHz close to a contact resonance of the probe. The image was acquired at 1 Hz scan speed with 512×256 pixels. The FFT amplitude was integrated over a window of +−20 kHz around the laser repetition rate, and this routine was implemented in the controller DSP. The IR spatial resolution is the same as before.

Note that the preferred embodiments of gated pulsing and detection (sample response extraction) via lock-in amplifier, boxcar integration, FFT or similar methods offer a speed advantage over the prior art. While previous single-pulse or multi-pulse excitation PFIR reported scan rates of 0.1-0.2 Hz, the preferred embodiments allow scan rates exceeding 0.5 Hz or 1 Hz, i.e., an improvement of 3-10×. This improvement is due to a larger duty cycle associated with pulsing during the entire contact time and the absence of un-pulsed PFT cycles without IR illumination. Furthermore, synchronization between pulsing and phase-sensitive detection allows phase-sensitive averaging where noise and artifacts are reduced and signal is not diminished via partially destructive interference. Background removal according to FIG. 5 further reduces noise and also the amplitude of any contact resonance oscillation that is caused by the ‘shock’ of the rapid snap-in contact at the start of the PFT probe-sample interaction cycle.

It is understood that in alternative embodiments, the wavelength region can be extended beyond the infrared of the preferred embodiment, for example to the ultraviolet, visible, near-infrared and terahertz or far-infrared spectral region. QCLs and optical parametric oscillators exist as pulsed and modulated light sources in the infrared. The UV, visible and near-IR is covered by laser sources such as solid state lasers, fiber lasers, diode lasers, optical parametric oscillators or gas lasers, as well as laser sources based on nonlinear frequency conversion comprising optical parametric generation, sum-frequency generation, harmonic generation, frequency combs and related methods. In the terahertz spectral region terahertz quantum cascade lasers are emerging, while terahertz gas lasers, terahertz antennas or free-electron lasers already exist to cover that range. In the extended wavelength range from UV to terahertz, the surface pulse force during laser pulsing can originate from several effects. In the terahertz region plasmon polaritons in graphene or cooper pair polaritons in superconductors exist that may induce an electromagnetic force between probe and sample under light excitation from charge redistribution and charge oscillation. Another example is phonon resonances leading to absorption and photoexpansion in the terahertz range. In the UV, visible and near-infrared range plasmonic resonances, e.g., in metal nanostructures, exist, absorbing energy for photoexpansion or altering electromagnetic fields through their charge oscillation or charge redistribution, thereby exerting a surface pulse force on the probe.

In another embodiment the sample is illuminated from the bottom instead of the top-down illumination of FIG. 2. Bottom illumination requires a transparent sample or sufficiently thin film (thickness within a few wavelengths) in the wavelength range of interest to allow transmission of light to the probed volume. Bottom illumination can have the benefit of less exposure of tip 203 and probe 201 to the laser pulses which can reduce artifacts that could occur when the probe itself absorbs light and gets heated. Another advantage is that bottom illumination may use a higher numerical aperture than top illumination since in top illumination the probe blocks part of the light while in bottom illumination the entire half space below the probe may be used for light focusing. Hence a smaller focus may result leading to a lower power requirement for the laser or less sample heating. The main benefit of bottom illumination is that it allows PFIR of samples in liquid environment, as described below.

For bottom illumination the sample may be placed or spin-coated for instance on a prism of a transparent material for the wavelength range of interest, e.g., ZnSe or ZnS or diamond or Germanium. The laser beam undergoes total internal reflection in order for the beam to propagate inside the sample while being evanescent in the air. In this way, only the sample is exposed to the radiation leading to strong light-matter interaction.

Such bottom-up configuration is most useful for measuring in liquid. The tip and sample region would then be surrounded by a fluid to study for instance biological specimen in their natural environment or electrochemical reactions. Since water absorption is minimized in the UV to near-infrared spectral region compared to the infrared region, water can be used as a liquid to study near-infrared absorption of biological matter in its native environment. Other suitable liquids, e.g., heavy water, with no or minimal absorption in the wavelength range of interest may be used to extend the wavelength range. Compared to top-down illumination with a longer light pass through the liquid, the water absorption would be minimized for bottom irradiation.

In bottom-up illumination using a prism, the total internal reflection of the light establishes an evanescent field that induces the light absorption from the IR mode or electronic transition of the sample within the evanescent field. The electronic transition can be in the ultraviolet, visible, or near-infrared, for instance using a fluorophore that is used in fluorescence microscopy. The absorption of electronic transition and subsequent non-radiative conversion leads to thermal effects or a pulse force in general with a mechanical response that is detected in PFIR. In another embodiment a prism and total internal reflection is not necessary, but the light is directly focused from underneath onto the tip-sample interaction region. The sample and its substrate (e.g., ZnSe) would need to be transparent for light to reach the tip-sample interaction volume in transmission.

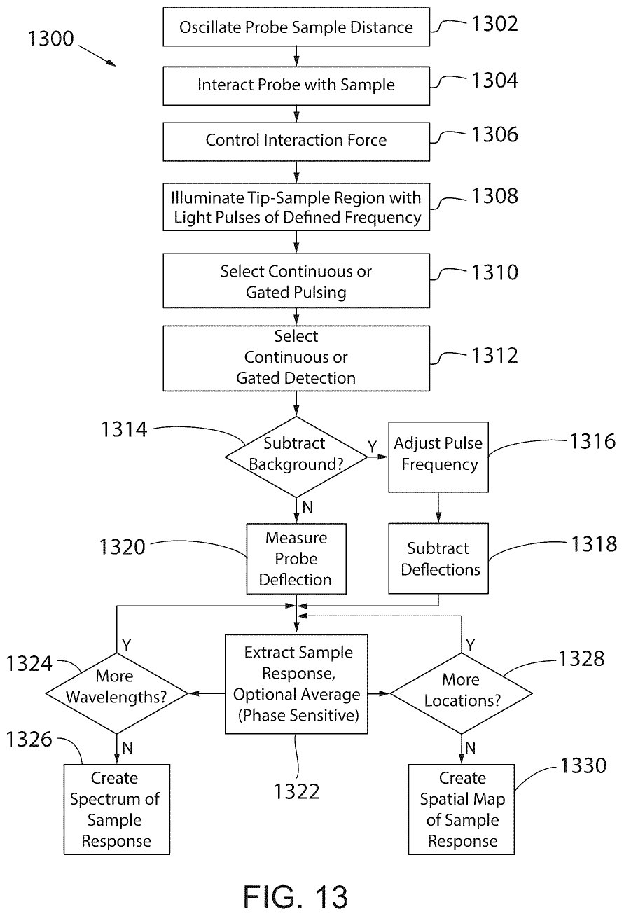

A method 1300 of some of the preferred embodiments is covered in the flow chart of FIG. 13. Method 1300 includes oscillating the probe-sample distance in step 1302, for instance in peak force tapping (PFT mode) at a frequency below a resonance frequency of the probe, e.g., at 2 kHz. In step 1304, the probe interacts with the sample during the tip-sample contact time at a certain xy position of the sample. In peak force tapping the maximum probe-sample interaction force is controlled in step 1306, e.g., to avoid sample damage while ensuring good tip-sample contact for sensing a laser-induced sample response in the following steps of method 1300. Next, in step 1308, the tip-sample region where the tip contacts the sample is illuminated with pulses from a light source at a wavelength of interest, e.g., an infrared laser is used in a preferred embodiment. The pulse repetition rate is preferably set at or near a contact resonance of the probe but off-resonant pulsing is acceptable also at the expense of signal-to-noise ratio.

In step 1310 the laser pulsing can either be chosen to occur continuously or gated. e.g., limited to a train of several pulses that substantially overlap with the probe-sample interaction cycle that is confined to the tip-sample contact time. In the latter “gated” case it is preferred but not necessary for the laser pulses to be synchronized to the probe-sample interaction cycle and arrive at the same relative point in time in each cycle. In step 1312 either continuous detection or gated detection during the probe-sample interaction cycle is selected. The slowly-varying background in the probe deflection that is repeating in each probe-sample interaction cycle can be subtracted in step 1314. To this end the laser pulse repetition rate needs to be set in step 1316 so that the deflection changes induced by the light pulses are 180-degrees out of phase between any two probe-sample interaction cycles, preferably between consecutive cycles. As an example, for a 2 kHz PFT frequency, a laser repetition rate of 751 kHz ensures phase reversal between consecutive cycles. In step 1318 the deflections of the cycles with 180-degree phase shift are subtracted synchronously (that means subtracting the same points in time relative to a synchronization time stamp like the peak force tapping control point). Alternatively, the background can be removed using un-pulsed probe-sample interaction cycles, or fits to the slowly-varying background as references for subtraction. If background removal is not desired, instead of the subtracted deflection in step 1318, the probe deflection in step 1320 is used for further processing. In step 1322 the sample response is then extracted from the deflection obtained in step 1320 or the processed deflection 1318. Synchronized averaging of the time-domain deflection data in either steps 1318 or 1320 is optional to increase signal to noise ratio prior to or as part of this extracting step 1322.

Extraction of the sample response in step 1322 is preferably based on use of a lock-in amplifier, a boxcar-like signal integrator or an FFT routine/algorithm. Again, averaging is optional and it is preferred to average phase-sensitive responses if the output of the extraction step provides phase information (such as for the lock-in amplifier or an FFT implementation). Note that the sample response can be extracted from the deflection after the deflection measurement of at least one full probe-sample interaction cycle, or in real-time in some implementations, especially when using a lock-in or signal integrator, i.e., during the probe-sample interaction cycle even before the cycle is completed. Once the sample response has been extracted, step 1322 can be repeated to collect sample responses at more wavelengths of the light source in step 1324. The resulting spectrum of sample responses as a function of wavelength can be created in step 1326 and may represent an absorption spectrum after normalization by the wavelength-dependent laser power in a preferred embodiment. Alternatively, the wavelength can be kept constant while changing the sample locations in step 1328 and repeating step 1322. In such a case a spatial map can be created in step 1330 to indicate position-dependent infrared absorption, for instance. It is also possible to combine steps 1326 and 1330 to create hyperspectral data: a spatial map that contains position-dependent spectra. Note that in another embodiment the laser repetition rate may need to be adjusted in step 1308 to follow in a frequency-tracking step the contact resonance during the spatial scanning when changing the xy position, or during the spectra acquisition when changing the wavelength.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

We claim:

1. An apparatus of performing spectroscopy of sub-micron regions of a sample with an atomic force microscope (AFM), the apparatus comprising:
a drive that generates an oscillating drive signal to cause a probe of the AFM to interact with the sample for multiple probe-sample interaction cycles, so as to produce a transient probe-sample interaction force, wherein the oscillating drive signal has a frequency below a resonance frequency of the probe;
at least one controller to control the transient probe-sample interaction force;
a tunable light source to illuminate the tip-sample region with light pulses to induce a sample modification;
a detector to measure probe deflection due at least in part to the induced sample modification; and
at least one of a lock-in amplifier and a signal integrator to extract sample responses to the light pulses from the measured probe deflection.

2. The apparatus of claim 1, wherein the at least one of a lock-in amplifier and a signal integrator is a lock-in amplifier, and the sample responses are phase sensitive, and wherein the phase sensitive sample responses are averaged.

3. The apparatus of claim 1, wherein the at least one controller creates a spatially resolved map indicative of absorbed infrared radiation using the sample responses, wherein the map is created over a region of the sample with at least 100×100 pixels in less than 5 minutes.

4. The apparatus of claim 1, wherein the oscillating drive signal frequency is at least 5× below the lowest resonance frequency of the probe.

5. The apparatus of claim 1, wherein the at least one controller:
times the pulses between probe-sample interaction cycles so as to cause a 180-degree phase change in the light induced probe deflection between at least two cycles;
subtracts the probe deflections corresponding to the at least two cycles; and
extracts a sample response from the subtracted probe deflections.

6. The method of claim 5, wherein at least one of a lock-in amplifier, a signal integrator and an FFT algorithm extracts the sample responses.

7. The apparatus of claim 1, wherein at least one of the light pulses and extracted sample responses is gated during the probe-sample contact time.

8. The apparatus of claim 7, wherein the at least one of the light pulses and extracted sample responses is gated in every cycle of probe-sample interaction.

9. The apparatus of claim 1, wherein the controller extracts at least one of a nano-mechanical property and a nano-electrical property from the sample responses.

10. A method of performing spectroscopy of sub-micron regions of a sample with an atomic force microscope (AFM), the method comprising:
causing a probe of the AFM to interact with the sample for multiple probe-sample interaction cycles, so as to produce a transient probe-sample interaction force, with an oscillating drive signal having a frequency below a resonance frequency of the probe;
controlling the transient probe-sample interaction force;
illuminating the tip-sample region with light pulses of a tunable light source to induce a sample modification during the tip-sample contact time;
measuring probe deflection due at least in part to the induced sample modification;
timing the pulses between probe-sample interaction cycles, so as to cause a 180-degree phase change in the light induced probe deflection between at least two cycles;
subtracting the probe deflections corresponding to the at least two cycles; and
extracting a sample response from the subtracting step.

11. The method of claim 10, wherein at least one of the illuminating step and the extracting step is gated during the probe-sample contact time.

12. The method of claim 11, wherein the at least two cycles are consecutive cycles.

13. The method of claim 10, wherein the sample responses are extracted with at least one of a lock-in amplifier, a signal integrator and an FFT algorithm to generate an output.

14. The method of claim 10, wherein the extracting step employs at least one of a lock-in amplifier and an FFT algorithm, and further comprising averaging the phase sensitive output.

15. The method of statement 10, wherein the oscillating drive signal frequency is at least 5× below the lowest resonance frequency of the probe.

16. A method of performing spectroscopy using an atomic force microscope (AFM), the method comprising:
causing a probe of the AFM to interact with the sample for multiple cycles, so as to produce a probe-sample interaction force, with an oscillating drive signal;
controlling the probe-sample interaction force;
providing a pulsed light source to generate a plurality of light pulses each having a pulse width;
directing the pulses at the sample where the probe is located causing an induced sample response;
measuring probe deflection due at least in part to the induced sample response; and
extracting sample responses to the light pulses from the measured probe deflection wherein the extracting step employs at least one of a lock-in amplifier and a signal integrator.

17. The method of claim 16, wherein at least one of the directing step and the extracting step is gated during the probe-sample contact time.

18. The method of claim 17, wherein the at least one of the directing step and the extracting step is gated in every cycle of the causing step.

19. The method of claim 16, wherein the causing step is performed in PFT mode.

20. The method of claim 16, wherein a resolution of the sample responses is sub-20 nm.
